(19) United States
(12) Patent Application Publication
(10) Pub. No.: US 2026/0310889 A1
(43) Pub. Date: Oct. 8, 2026

(54) Systems, Methods, and Graphical User Interface (GUI) for Consolidating Organizational Functions and Controlling Document Storage in a Multiuser Software Environment

(71) Applicant: Richard Merkin, Marina Del Rey, CA (US)

(72) Inventor: Richard Merkin, Marina Del Rey, CA (US)

(21) Appl. No.: 19/060,381

(22) Filed: Feb. 21, 2025

(51) Int. Cl. G06F 40/197; G06Q 10/107

(52) U.S. Cl. CPC G06F 40/197; G06Q 10/107

(57) ABSTRACT

A method of tracking and maintaining document version history in a multiuser software environment includes generating a document upload tool to be displayed on a graphical user interface accessible by a plurality of computing devices. The document upload tool may include a task selector for selecting between a first task of uploading a new document and a second task of updating an existing document. The document upload tool may further include a version status indicator for indicating whether a file to be uploaded includes redlining relative to a previously uploaded version of the existing document. The method may further include receiving a designation of the file to be uploaded and preventing the file from being uploaded in a case where a previously uploaded version of the existing document does not include redlining and the version status indicator indicates that the file to be uploaded does not include redlining.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

For a large organization, such as a managed care organization that contracts with many interrelated parties in a healthcare provider network, the task of keeping track of and managing access to documents is of real importance. Inconsistencies that arise due to the use of disparate systems for the various management functions may lead to operational inefficiency as a best-case scenario. When these inconsistencies cause a failure in a critical area such as security or compliance-related documentation, the result can be legal liability and catastrophic loss to the organization.

Under the circumstances, training is critically important in order to encourage correct document storage (e.g., naming conventions, enforcement of access rights, etc.), to ensure compliance with regulatory requirements, and to otherwise minimize risk. Unfortunately, even with strong training programs in place, people are prone to human error. Especially in the case of a large organization, one or two seemingly harmless errors may be compounded by downstream reliance on the erroneously stored documents, creating a ripple effect that has the potential to negatively impact many stakeholders and the organization as a whole. Catching and correcting such errors before they cause harm is a daunting proposition, requiring the dedication of additional human resources to oversee the various document management systems. Rather, what is needed are technical innovations to the underlying software platforms to enable them to prevent such errors from being made in the first place.

### BRIEF SUMMARY

The present disclosure contemplates various systems, methods, and graphical user interface (GUI) for overcoming the above drawbacks accompanying the related art. One aspect of the embodiments of the present disclosure is a computer program product comprising one or more non-transitory program storage media on which are stored instructions executable by one or more processors or programmable circuits to perform operations for tracking and maintaining document version history in a multiuser software environment. The operations may comprise generating a document upload tool to be displayed on a graphical user interface accessible by a plurality of computing devices. The document upload tool may include a task selector for selecting among tasks including a first task of uploading a new document and a second task of updating an existing document. The document upload tool may further include a version status indicator for indicating, in a case where the second task is selected, whether a file to be uploaded includes redlining relative to a previously uploaded version of the existing document. The operations may further comprise receiving a designation of the file to be uploaded and preventing the file from being uploaded in a case where the second task is selected, the previously uploaded version of the existing document does not include redlining, and the version status indicator indicates that the file to be uploaded does not include redlining.

Another aspect of the embodiments of the present disclosure is a method of tracking and maintaining document version history in a multiuser software environment. The method may comprise generating a document upload tool to be displayed on a graphical user interface accessible by a plurality of computing devices. The document upload tool may include a task selector for selecting among tasks including a first task of uploading a new document and a second task of updating an existing document. The document upload tool may further include a version status indicator for indicating, in a case where the second task is selected, whether a file to be uploaded includes redlining relative to a previously uploaded version of the existing document. The method may further comprise receiving a designation of the file to be uploaded and preventing the file from being uploaded in a case where the second task is selected, the previously uploaded version of the existing document does not include redlining, and the version status indicator indicates that the file to be uploaded does not include redlining.

Another aspect of the embodiments of the present disclosure is a system for tracking and maintaining document version history in a multiuser software environment. The system may comprise one or more servers configured to generate a document upload tool to be displayed on a graphical user interface accessible by a plurality of computing devices. The document upload tool may include a task selector for selecting among tasks including a first task of uploading a new document and a second task of updating an existing document. The document upload tool may further include a version status indicator for indicating, in a case where the second task is selected, whether a file to be uploaded includes redlining relative to a previously uploaded version of the existing document. The system may further comprise a first computing device configured to access the graphical user interface and designate the file to be uploaded. The one or more servers may prevent the file from being uploaded in a case where the second task is selected, the previously uploaded version of the existing document does not include redlining, and the version status indicator indicates that the file to be uploaded does not include redlining.

The system may comprise a second computing device configured to access the graphical user interface. The one or more servers may be configured to generate a list of documents and corresponding version statuses to be displayed on the graphical user interface, each version status indicating to a user of the second computing device whether the corresponding document includes redlining. The one or more servers may be configured to generate a document filtering tool to be displayed on the graphical user interface, the document filtering tool including one or more filter selectors by which the user of the second computing device may filter the displayed list of documents. The one or more filter selectors may include a version status filter selector by which the user of the second computing device may select whether documents that include redlining appear in the list of documents.

Likewise, in any of the above aspects, the method and/or operations may comprise generating a list of documents and corresponding version statuses to be displayed on the graphical user interface, each version status indicating whether the corresponding document includes redlining. The method and/or operations may comprise generating a document filtering tool to be displayed on the graphical user interface, the document filtering tool including one or more filter selectors for filtering the displayed list of documents. The one or more filter selectors may include a version status filter selector for selecting whether documents that include redlining appear in the list of documents. The method, the operations, and/or the functionality of the one or more servers may comprise providing respective links for opening each document in the list.

In any of the above aspects, the method, the operations, and/or the functionality of the one or more servers may comprise assigning one or more identifiers to the file to be uploaded. The one or more identifiers may include a version identifier that is automatically assigned. In a case where the second task is selected (i.e., the task of updating an existing document as opposed to uploading a new document), the version identifier may be automatically assigned based on a version identifier of the previously uploaded version of the existing document. The one or more identifiers may include a document type identifier that is selectable from a set of document type identifiers including one or more selected from the group consisting of: Policy & Procedure, Desktop Procedure, Appendix, and Report.

The document upload tool may be accessible from a plurality of domains of the multiuser software environment, each of the plurality of domains being associated with a different department or functional area of a company. The one or more identifiers may include a document category identifier that is selectable from a predefined set of document categories associated with the particular domain from which the document upload tool is accessed. The plurality of domains may include two or more domains selected from the group consisting of: compliance, credentialing, cybersecurity, development, California Department of Managed Healthcare (DMHC) filing, eligibility, health plan contract, HR & payroll, quality improvement, revenue, utilization management, and claims.

In any of the above aspects, the method, the operations, and/or the functionality of the one or more servers may comprise generating a group email management tool to be displayed on the graphical user interface. The group email management tool may include one or more selectors for selecting user email addresses to receive automatic email notifications of new documents and/or updates to existing documents. The method, the operations, and/or the functionality of the one or more servers may comprise, in response to the file being uploaded, sending an email notification to the selected user email addresses.

The document upload tool and the group email management tool may be accessible from a plurality of domains of the multiuser software environment, each of the plurality of domains being associated with a different department or functional area of a company. The email notification may be sent to the selected user email addresses in response to the file being uploaded from the same particular domain in which the user email addresses were selected.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a screenshot showing a navigation page of a graphical user interface (GUI), together with a navigation bar;

FIG. 2 is another screenshot showing the navigation page;

FIG. 3 is a screenshot showing the navigation bar;

FIG. 4 is a screenshot showing a document summary page of the GUI, together with the navigation bar;

FIG. 5 is a screenshot showing a document upload tool of the GUI;

FIG. 6 is another screenshot showing the document upload tool;

FIG. 7 is another screenshot showing the document upload tool;

FIG. 8 is another screenshot showing the document upload tool;

FIG. 9 is another screenshot showing the document upload tool;

FIG. 10 is another screenshot showing the document upload tool;

FIG. 11 is another screenshot showing the document upload tool;

FIG. 12 is another screenshot showing the document upload tool;

FIG. 13 is another screenshot showing the document upload tool;

FIG. 14 is another screenshot showing the document summary page;

FIG. 15 is another screenshot showing the document upload tool;

FIG. 16 is another screenshot showing the document upload tool;

FIG. 17 is another screenshot showing the document upload tool;

FIG. 18 is another screenshot showing the document summary page;

FIG. 19 is a screenshot showing a group email tool of the GUI;

FIG. 20 is a screenshot showing a schedule meeting page of the GUI;

FIG. 21 is a screenshot showing a meeting summary page of the GUI;

FIG. 22 is a screenshot showing an update meeting information tool of the GUI;

FIG. 23 is a screenshot showing a meeting document roster of the GUI;

FIG. 24 is a screenshot showing a claims audit report page of the GUI;

FIG. 25 is a screenshot showing a compliance internal audit roster of the GUI;

FIG. 26 is a screenshot showing a create compliance audit page of the GUI;

FIG. 27 is a screenshot showing a compliance internal audit tool of the GUI;

FIG. 28 is another screenshot showing the compliance internal audit tool;

FIG. 29 is a screenshot showing a compliance internal audit document upload tool of the GUI;

FIG. 30 is a screenshot showing a corrective actions tool of the GUI;

FIG. 31 is a screenshot showing a compliance internal audit tool of the GUI;

FIG. 32 is another screenshot showing the corrective actions tool;

FIG. 33 is a screenshot showing a DOFR health plan contract page of the GUI;

FIG. 34 is a screenshot showing a termed DOFR selector of the GUI;

FIG. 35 is a screenshot showing a DOFR summary page of the GUI;

FIG. 36 is a screenshot showing a DOFR detail view of the GUI;

FIG. 37 is a screenshot showing a carve-out vendor summary page of the GUI;

FIG. 38 is a screenshot showing a new carve-out vendor tool of the GUI;

FIG. 39 is a screenshot showing an edit vendor information tool of the GUI;

FIG. 40 is a screenshot showing a cybersecurity framework page of the GUI;

FIG. 41 is a screenshot showing a cybersecurity function categories page of the GUI;

FIG. 42 is a screenshot showing a category details page of the GUI;

FIG. 43 is another screenshot showing the cybersecurity framework page;

FIG. 44 is a screenshot showing a regulations page of the GUI;

FIG. 45 is another screenshot showing the regulations page;

FIG. 46 is a screenshot showing a cybersecurity evidence page of the GUI;

FIG. 47 is a screenshot showing a data flow summary page of the GUI;

FIG. 48 is a screenshot showing a data processing roster of the GUI;

FIG. 49 is another screenshot showing the data processing roster;

FIG. 50 is a screenshot showing a business environment page of the GUI;

FIG. 51 is a screenshot showing a business environment supporting applications page of the GUI;

FIG. 52 is a screenshot showing a company equipment page of the GUI;

FIG. 53 is a screenshot showing an IT asset report page of the GUI;

FIG. 54 is as screenshot showing a goal display of the GUI;

FIG. 55 is a screenshot showing another cybersecurity evidence page of the GUI;

FIG. 56 is a screenshot showing a user access validation page of the GUI;

FIG. 57 is a screenshot showing another goal display of the GUI;

FIG. 58 is a screenshot showing an application user roster of the GUI;

FIG. 59 is a screenshot showing another application user roster of the GUI;

FIG. 60 is a screenshot showing another application user roster of the GUI;

FIG. 61 is another screenshot showing the application user roster of FIG. 60;

FIG. 62 is a screenshot showing a multi-factor authentication report page of the GUI;

FIG. 63 is a screenshot showing another goal display of the GUI;

FIG. 64 is a screenshot showing a privileged access management active directory page of the GUI;

FIG. 65 is a screenshot showing a privileged access management detail view of the GUI;

FIG. 66 is a screenshot showing another goal display of the GUI;

FIG. 67 is a screenshot showing a privileged access management local server page of the GUI;

FIG. 68 is a screenshot showing another privileged access management detail view of the GUI;

FIG. 69 is a screenshot showing another goal display of the GUI;

FIG. 70 is a screenshot showing an encryption software controls page of the GUI;

FIG. 71 is another screenshot showing the cybersecurity framework page;

FIG. 72 is a screenshot showing a cybersecurity trainings page of the GUI;

FIG. 73 is a screenshot showing a cybersecurity meeting document roster of the GUI;

FIG. 74 is a screenshot showing a cybersecurity business environment page of the GUI;

FIG. 75 is another screenshot showing the cybersecurity business environment page;

FIG. 76 is a screenshot showing a cybersecurity newsletter roster of the GUI;

FIG. 77 is a screenshot showing a cybersecurity employee training report roster of the GUI;

FIG. 78 is a screenshot showing a training session report of the GUI;

FIG. 79 is another screenshot showing the cybersecurity framework page;

FIG. 80 is a screenshot showing a security performance management page of the GUI;

FIG. 81 is a screenshot showing another goal display of the GUI;

FIG. 82 is a screenshot showing risk vector findings display of the GUI;

FIG. 83 is a screenshot showing a web application security page of the GUI;

FIG. 84 is a screenshot showing a managed detection and response summary page of the GUI;

FIG. 85 is a screenshot showing another goal display of the GUI;

FIG. 86 is a screenshot showing a cybersecurity internal audit tool of the GUI;

FIG. 87 is another screenshot showing the cybersecurity internal audit tool;

FIG. 88 is a screenshot showing a HITRUST controls page of the GUI;

FIG. 89 is a screenshot showing a HITRUST maturity evaluation page of the GUI;

FIG. 90 is another screenshot showing the cybersecurity framework page;

FIG. 91 is a screenshot showing a cybersecurity technology stack page of the GUI;

FIG. 92 is another screenshot showing the cybersecurity technology stack page;

FIG. 93 is another screenshot showing the cybersecurity technology stack page;

FIG. 94 is a screenshot showing a cybersecurity protocols and procedures page of the GUI;

FIG. 95 is a screenshot showing a compliance trainings page of the GUI;

FIG. 96 is a screenshot showing a compliance meeting document roster of the GUI;

FIG. 97 is a screenshot showing a compliance newsletter roster of the GUI;

FIG. 98 is a screenshot showing a compliance employee training report roster of the GUI;

FIG. 99 is a screenshot showing another training session report of the GUI;

FIG. 100 is a screenshot showing a compliance privacy walk-through attestation page of the GUI; and

FIG. 101 is another screenshot showing the compliance privacy walk-through attestation page.

### DETAILED DESCRIPTION

The present disclosure encompasses various embodiments of systems and methods for consolidating organizational functions and controlling document storage in a multiuser software environment, including tracking and maintaining document version history and access control. The detailed description set forth below in connection with the appended drawings is intended as a description of several currently contemplated embodiments and is not intended to represent the only form in which the disclosed invention may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

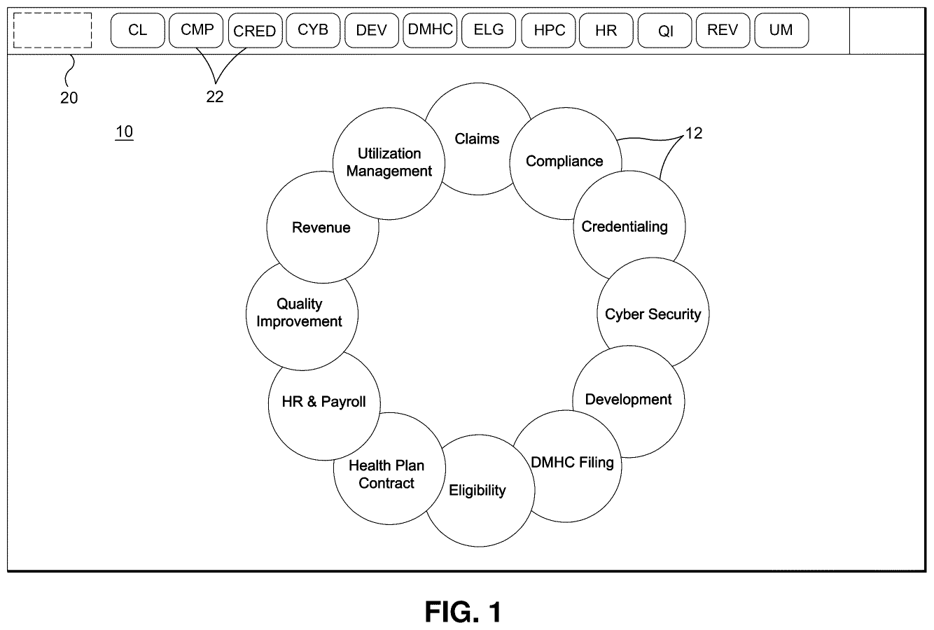

FIG. 1 is a screenshot showing a navigation page 10 of a graphical user interface (GUI), together with a navigation bar 20. The GUI may be the user-facing front end of a software platform that embodies the innovative systems and methods described herein. More specifically, the GUI may be a website or may be the GUI of a mobile or desktop application (“app”), for example, and may be accessible by multiple users via a computing device such as a smartphone, tablet, or desktop computer. A browser or app on a user's computing device may display and facilitate user interaction with the GUI through communication with one or more servers over a network such as the Internet or a private network. A user may arrive at the navigation page 10 after successful authentication, which may include providing login credentials such as username, password, multifactor authentication code, etc. at a login page or login prompt.

The navigation page 10 may serve as a homepage of the GUI, for example, and may include one or more navigation buttons 12 for navigating to different pages of the GUI. As shown, the navigation buttons 12 may facilitate navigation to various domains of organizational functions or departments. In the case of a managed care organization, for example, the domains may include Claims, Compliance, Credentialing, Cybersecurity, Development, California Department of Managed Health Care (DMHC) Filing, Eligibility, Health Plan Contracts, Human Resources (HR) and Payroll, Quality Improvement, Revenue, and Utilization Management. On the navigation page 10, the navigation buttons 12 may be prominently displayed as bubbles or icons, which may be color-coded and/or include a picture or other visual cue corresponding to each particular domain. Navigation to the same pages may redundantly be performed using corresponding navigation buttons 22 of the navigation bar 20 (e.g., “CL” corresponding to “Claims,” “CMP” corresponding to “Compliance,” etc.), with the difference being that the navigation bar 20 may persist in one portion of the GUI (e.g., at the top of the screen) as the user navigates to other pages of the GUI. While not illustrated, the navigation bar 20 may also include a link to the navigation page 10 or other homepage (e.g., on the left-hand side of the navigation bar 20) and/or menus for accessing technical help, changing account or profile settings, logging out, etc. (e.g., on the right-hand side of the navigation bar 20). It is noted that the navigation bar 20 may remain accessible (e.g., at the top of the screen) as a user navigates to the various pages and other elements of the GUI described herein, even if it is not specifically depicted in a given drawing of the GUI.

By consolidating many or all organizational functions within the same GUI, the disclosed systems and methods may advantageously provide the user with a consistent interface for performing the various tasks associated with each domain. In some instances, the GUI may provide identical screen layouts and functionality across domains that conventionally have been managed using separate software applications having very different interfaces. Examples may include summary pages, dashboards, and tools for accessing documents, communicating with other users, and scheduling meetings, all of which may address equivalent needs across different domains and may thus benefit from consistency in how they look and operate. This may reduce the learning curve for new users and consequently the likelihood of human error. In other instances, unique pages or tools may exist within one domain or another, such as managing audits within the Claims domain, reviewing Division of Financial Responsibility (DOFR) within the Health Plan Contracts domain, or other domain-specific pages. In these cases as well, consolidation of such domain-specific functionality within the same GUI as described may still advantageously increase efficiency as users may be able to perform all such management functions within a single login session and may freely navigate between the various domains without needing to open a separate application or move to a different workstation.

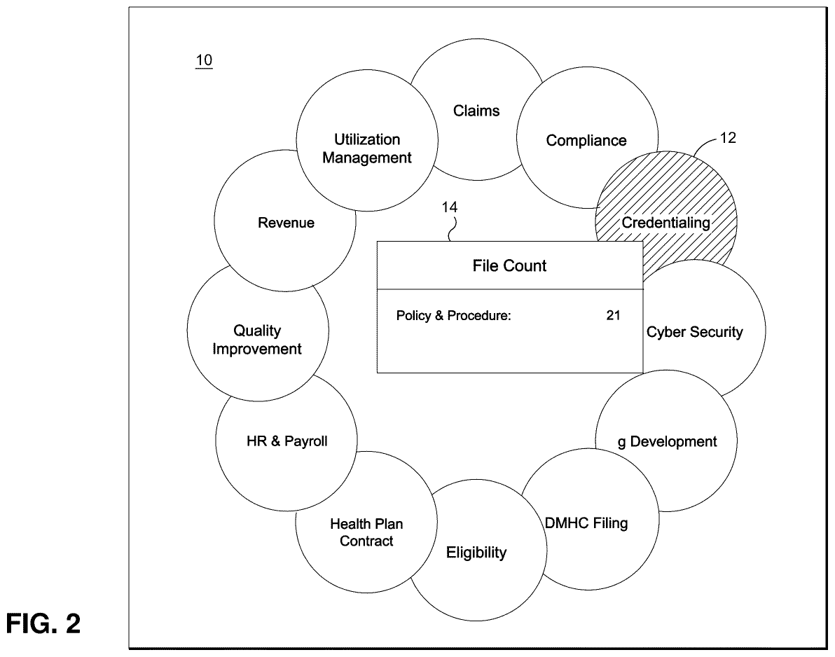

Referring to FIG. 2, when a user clicks, taps, or otherwise interacts with a navigation button 12, the GUI may present a navigation popup 14 or other GUI element corresponding to the selected navigation button 12. The navigation popup 14 may present a file count displaying the number and types of documents that the selected domain contains. As shown, for example, the user has clicked the Credentialing navigation button 12 (as represented by shading in FIG. 2), and the resultant navigation popup 14 indicates that there are twenty-one Policy & Procedure documents. In the context of a managed care organization, a Policy & Procedure document (which may itself refer to ancillary documents such as appendices, desktop procedures and reports) may be a written set of steps, processes, and rules used to unify and streamline the behavior of the people in a particular area or department. In general, the disclosed GUI may serve as a library or knowledge base for employees and managers, housing several types of documents, such as Plans, Charters, Policy & Procedure documents, and Meeting documents in the case of a managed care organization. By a further user interaction with the navigation button 12 or navigation popup 14, or a different interaction (such as a right click rather than a left click), the user may navigate to the Credentialing domain pages of the GUI (e.g., a summary page thereof, as described in more detail below).

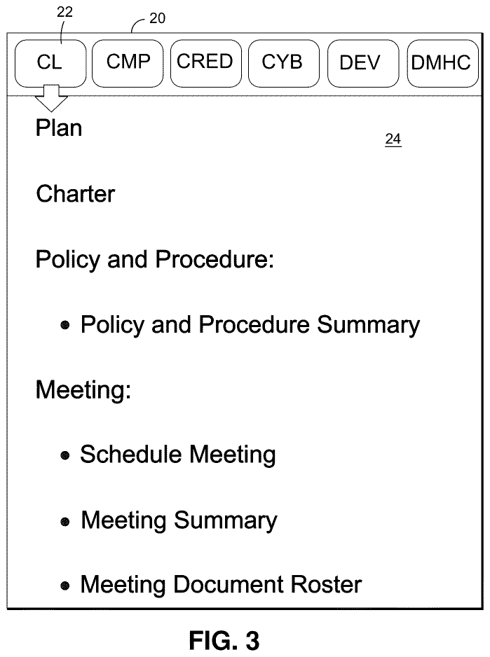

FIG. 3 is a closeup view of the navigation bar 20, which contains navigation buttons 22 (e.g., small tiles as opposed to the larger navigation buttons 12 of the navigation page 10). When the user interacts with one of the navigation buttons 22, such as the “CL” (Claims) button 22, the GUI may display a navigation popup 24 that is analogous to the navigation popup 14 of the navigation buttons 12. In this instance, the navigation popup 24 shows each of the pages available within the Claims domain, including a Plan page, a Charter page, one Policy & Procedure summary page, and three pages related to Meeting documents (Schedule Meeting, Meeting Summary, and Meeting Document Roster). The navigation popup 24 may also be referred to as the “main menu” of the domain in question. The user may select from the list of pages to navigate to the corresponding pages of the GUI. For example, by selecting “Plan” from the navigation popup 24, the user may be taken to the Claims department's Plan document, which may be downloadable in .pdf format, for example. Likewise, by selecting “Charter” from the navigation popup 24, the user may be taken to the Claims department's Charter document. The navigation popup 24 may include the same or different information as the navigation popup 14 and may, for example, additionally include the numbers of each document type. In the illustrated example, the navigation popup 24 takes the form of a drop-down menu, as represented by the arrow below the “CL” button 22 and subsequent listing of pages.

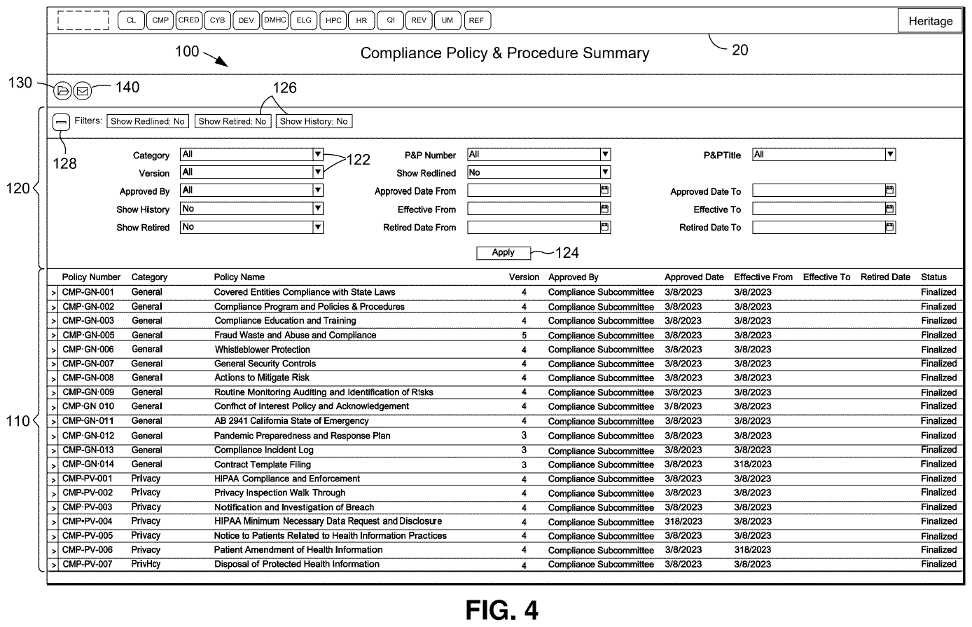

FIG. 4 shows a document summary page 100 of the GUI (together with the navigation bar 20 at the top of the screen). The document summary page 100 shown in FIG. 4 is, more specifically, a document summary page 100 of Policy & Procedure documents within the Compliance domain. The same document summary page 100, functionally and technologically speaking, may exist for many or all of the different domains, with each document summary page 100 differing only in the identity of the documents and the inclusion of any domain-specific data fields. The document summary page 100 may, in major part, comprise a document list 110 organized according to various data fields (e.g., Policy Number, Category, Policy Name, Version, Approved By, Approved Date, Effective From, Effective To, Retired Date, and Status). The document list 110 may be arranged as a table or grid as shown and may be sortable by each data field (corresponding to the columns) and navigable using one or more slide bars, paging buttons, etc. Each entry in the document list 110 (e.g., each item of the Policy Name column) may be a link to the document in question, which may be downloadable in .pdf format, for example. The document summary page 100 may additionally comprise a filter tool 120 (e.g., above the document list 110) for refining the list of documents that is displayed in the document list 110. Multiple filters may be applied using filter selectors 122 (e.g., Category, Approved By, Show History, Show Retired, P&P Number, Show Redlined, Approved Date From/To, Effective From/To, Retired Date From/To, P&P Title), and the currently active filters 126 may be displayed such as at the top of the filter tool 120 (“Show Redlined: No,” “Show Retired: No,” “Show History: No”). As filters are applied (e.g., using an apply button 124) or removed, the documents that appear in the document list 110 may be updated to include only those meeting the conditions of the active filters 126. A hide/show button 128 may be toggled to collapse or expand the filter tool 120 as needed in order to make more efficient use of limited screen real estate by displaying more entries of the document list 110 (e.g., especially in the case of a mobile device having a small display size).

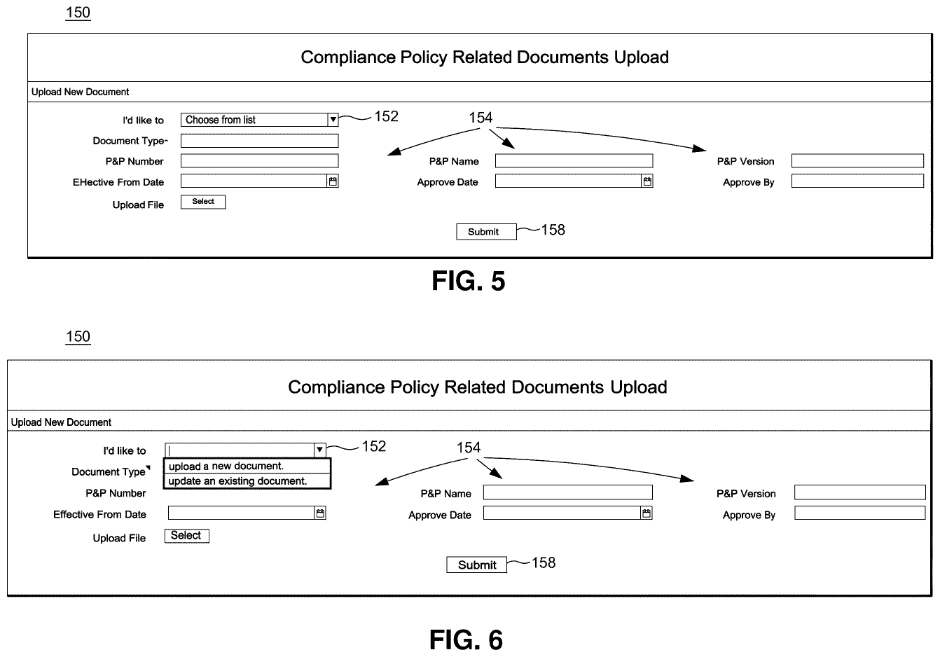

By interacting with a document upload button 130 (e.g., under the title bar of the document summary page 100) the user may navigate to or open a document upload tool 150 as shown in FIG. 5. The document upload tool 150 may be a separate page or may be displayed along with the document summary page 100 (e.g., as a popup window superimposed on the document summary page 100 or as a display pane adjacent to the document summary page 100). Like the document summary page 100, the document upload tool 150 may be substantially the same for many or all of the domains within the GUI, making document uploads easy and intuitive for users even if they are otherwise unfamiliar with the particular domain in question. The particular document upload tool 150 shown in FIG. 5 is for Compliance Policy Related Documents Upload and would be directly navigable from the document summary page 100 of Policy & Procedure documents within the Compliance domain (e.g., linked via the document upload button 130 on the relevant document summary page 100). The document upload tool 150 may include a task selector 152 for selecting among tasks including a first task of uploading a new document and a second task of updating an existing document. The desired task may be selected from a drop-down menu, for example, as shown in FIG. 6. The document upload tool 150 may further include one or more document data fields 154, such as Document Type, P&P Number, P&P Name, P&P Version, Effective From Date, Approve Date, and Approve By, which may be filled in by the user and/or auto-populated when uploading a document in order to associate one or more corresponding identifiers with the document.

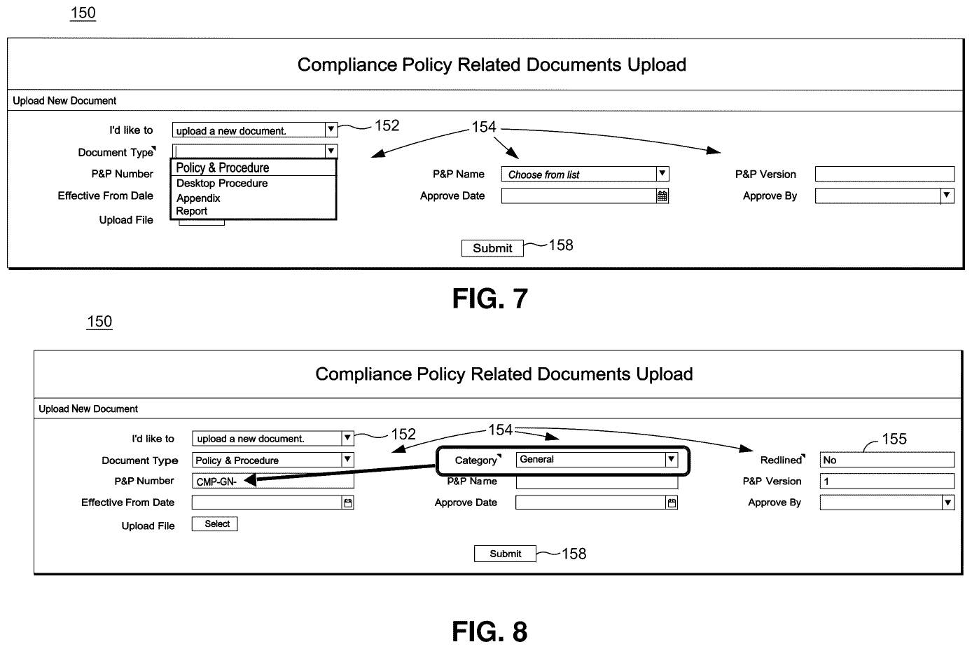

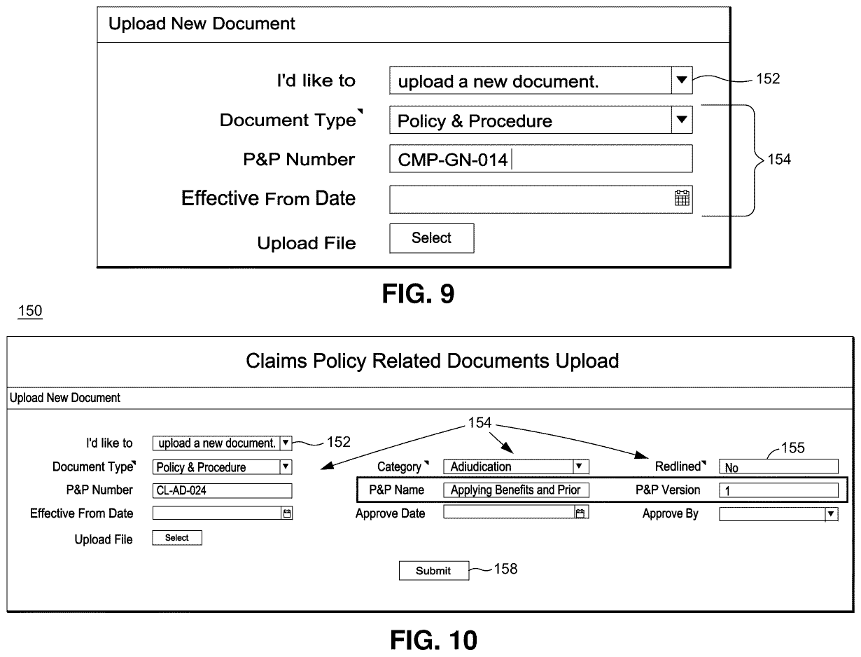

Referring to FIGS. 6-13, a user wishing to upload a new document may first select this task from the task selector 152. In the “Document Type” data field 154, the user may indicate which type of document is to be uploaded by choosing from another dropdown menu as shown in FIG. 7. These may include Policy & Procedure documents as well as ancillary documents such as desktop procedures, appendices, and reports. Depending on the selected document type (“Policy & Procedure” in the illustrated example), additional data fields 154 may be added to the document upload tool 150, such as “Category” and “Redlined” as shown in FIG. 8. The particular items that may be selected within each data field 154 may be predefined based on which domain the user has accessed the document upload tool 150 from (which may be shown in the title bar, e.g., “Compliance Policy Related Documents Upload”). In the example of FIG. 8, the user has selected “General” from the predefined list of items in the “Category” data field 154. In response to this selection, the GUI may auto-populate one or more other data fields 154. Here, the “P&P Number” data field 154 has been auto-populated with a predefined prefix “CMP-GN-” based on the Compliance domain and the selected “General” category, and the user may fill in the remainder of the P&P number according to a standard numbering convention (e.g., with the next available number) as shown in FIG. 9.

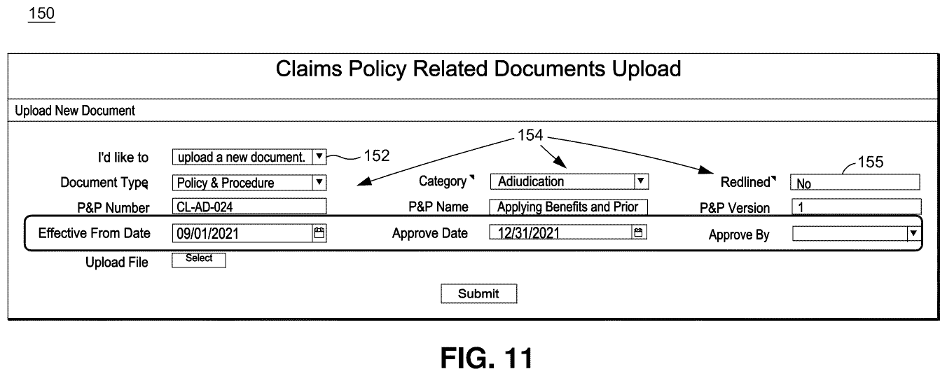

Referring to FIG. 10 (which continues the same process of FIGS. 5-9 but with screenshots showing the identical functionality in the Claims domain), the user may then enter an appropriate name for the document in the “P&P Name” data field 154 (e.g., the name of the file to be uploaded) and a version number of the document in the “P&P Version” data field 154. If this is the first time the document is being uploaded, the GUI may automatically assign the number “1” in the “P&P Version” data field 154. Lastly, referring to FIG. 11, the user may enter the appropriate dates in the “Effective From Date” and “Approve Date” data fields 154 (e.g., using a calendar-type date picker) and the appropriate party in the “Approve By” data field 154. The “Redlined” data field 154, which is described in more detail below, may function as a version status indicator 155 indicating whether the file to be uploaded includes redlining relative to an earlier version. It is noted that the “Redlined” data field 154 may be grayed out or otherwise disabled when the task selector 152 is set to upload a new document (since by definition there is no prior version).

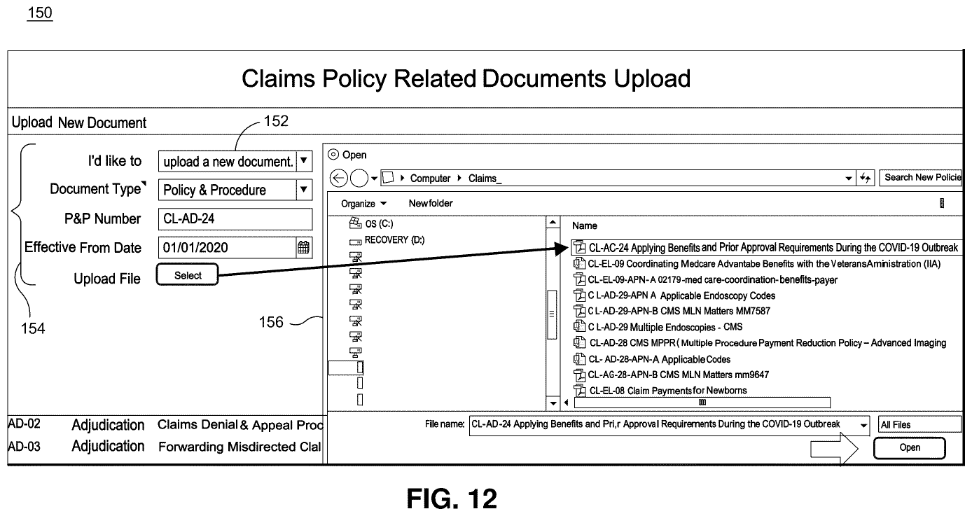

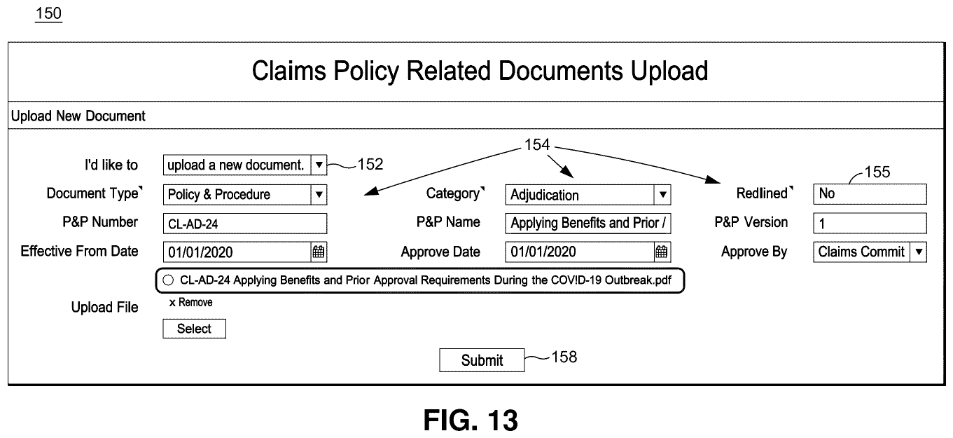

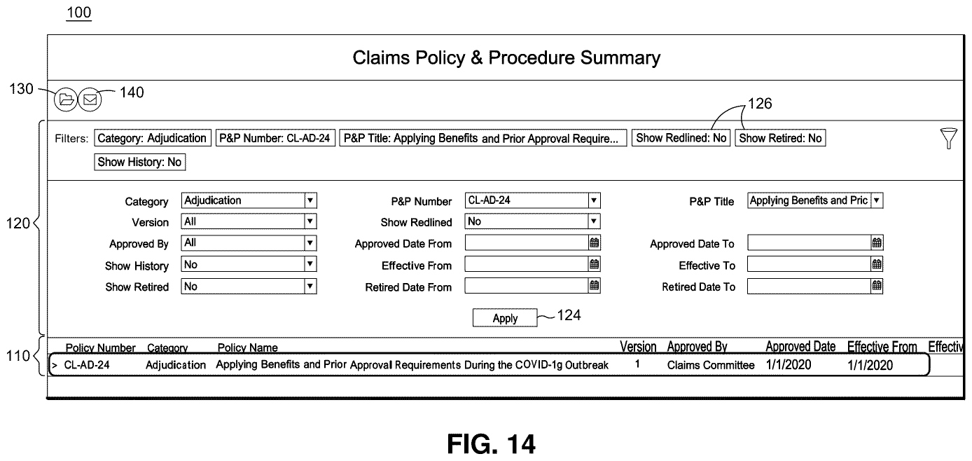

Referring to FIG. 12, the user may then click on the “Select” button where the screen says “Upload File” in order to open up a file selector 156 (e.g., as a popup window, display pane, etc.) to allow the user to browse local files on his/her computing device or networked device and choose a file to be uploaded. The user may highlight the document to be uploaded and click “Open” within the file selector 156, for example, to designate the file to be uploaded. With the software platform having thus received the designation of the file to be uploaded, the name of the document that was just selected to be uploaded may then appear in the document upload tool 150 as shown in FIG. 13, along with an option to delete the file (by clicking “Remove”) and start over. When satisfied that the designation of the file is correct and the data fields 154 are correct, the user may click the submit button 158 to complete the uploading of the new document. The software platform may assign one or more identifiers to the file to be uploaded, which may include a document type identifier based on the selection in the “Document Type” data field 154, a version identifier based on the selection in a version data field 154 (e.g., “P&P Version”), a document category based on the selection in the “Category” data field 154, etc. Referring to FIG. 14, the newly uploaded document will now appear on the document summary page 100 (here shown identically for the Claims domain as above for the Compliance domain) in the document list 110, assuming that it is not excluded by any active filters 126.

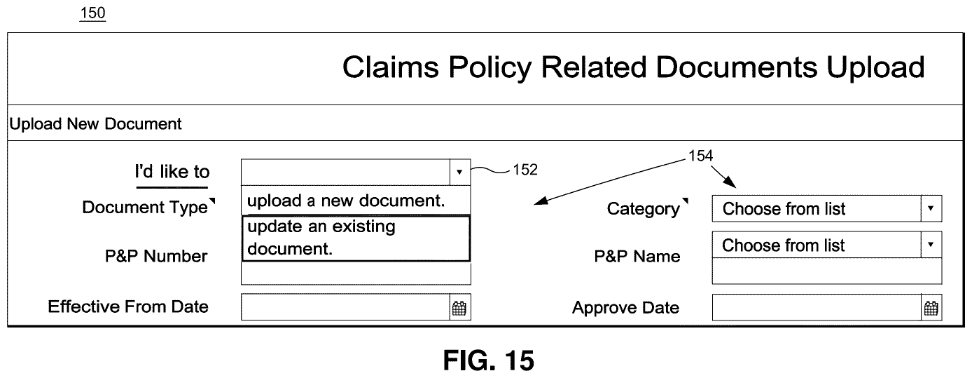

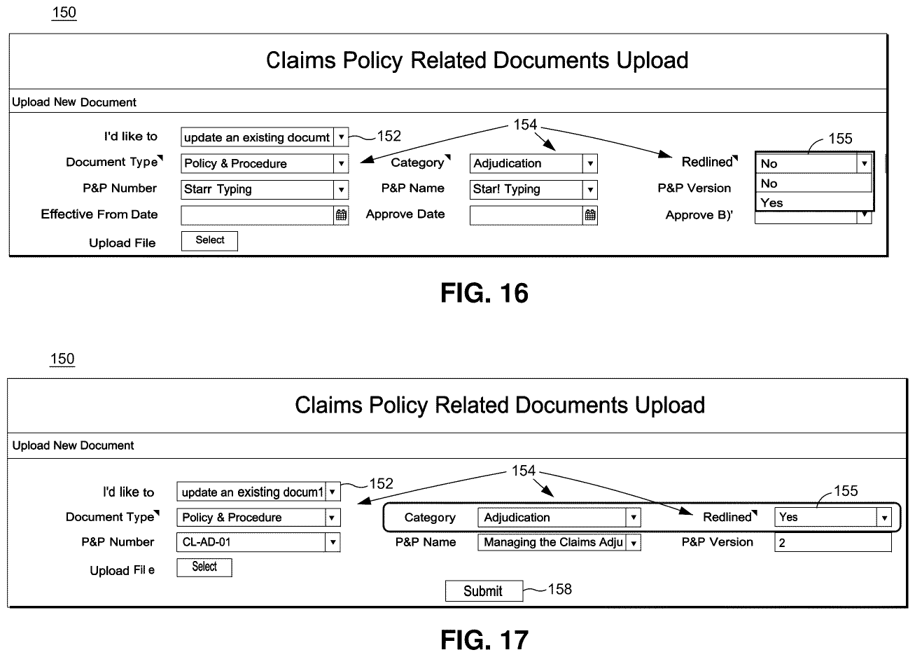

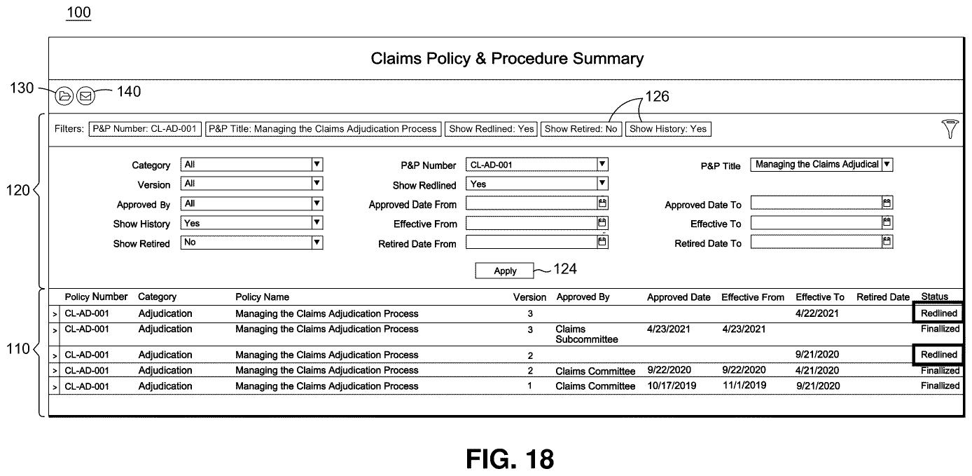

Many of the documents that are routinely stored by large organizations exist in multiple versions. A new version of a stored document may be needed for various reasons, such as when an early draft is revised or corrected by a supervisor or when the information the document contains changes over time due to activities of the organization, evolving legal rules and standards, shifts in priorities or management, or other factors. Advantageously, the GUI contemplated herein is “smart” in the sense that it handles updates to documents differently than it handles new documents, reducing the likelihood of human error as compared to conventional systems that do not distinguish between new and updated documents. Referring to FIG. 15, a user wishing to update an existing document may first select this task from the task selector 152. The user may narrow the range of possible documents to update using the “Document Type” and “Category” data fields 154 (e.g., by selecting from dropdown menus). As shown in FIG. 16, the user may use the version status indicator 155 to indicate whether the file to be uploaded includes redlining. For example, the user may select “Yes” in the “Redlined” data field 154 (which may function as the version status indicator 155). As shown in FIG. 17, the user may then select the document to be updated by using the “P&P Number” data field 154, which is now a dropdown menu populated with existing documents (rather than a free entry field) because the “update” task is selected in the task selector 152. It is noted that the dropdown menu may be automatically populated based on the selected “Document Type” and “Category.” The GUI may automatically populate the “P&P Name” data field 154 based on the number that is selected by the user in the “P&P Number” data field 154. Alternatively, the user may first select a document name from the “P&P Name” data field 154 (from a drop-down menu that is populated based on the selected “Document Type” and “Category”), and the “P&P Number” data field 154 may then automatically be populated to reflect the “P&P Name” entry. The “P&P Version” data field 154 may automatically be populated according to the number of times the particular document has been updated, e.g., “2” in a case where the user is uploading the first update. The user may then upload the desired file as described above, causing it to appear in the document list 110 on the appropriate summary page 100 with the “Redlined” status as shown in FIG. 18 (provided that the “Show Redlined: Yes” filter 126 is active).

Unlike conventional systems, the “smart” GUI of the disclosed software platform may advantageously disallow users to update a document without first uploading a redlined version. For example, the GUI may prevent the file from being uploaded in a case where the second task (“updating an existing document”) is selected, the previously uploaded version of the existing document does not include redlining (“Redline: No”), and the version status indicator 155 indicates that the file to be uploaded does not include redlining (“Redline: No”). Under these circumstances, since neither the file being uploaded nor the previous version of the document has been designated as containing redlining, the user's attempted upload is understood to be a new version containing undocumented revisions, which could potentially create confusion and increase the likelihood of downstream human error. When the user presses the submit button 158 in such a case, the GUI may prevent or refuse the submission and may, for example, display an appropriate error message, e.g., “Document is not uploaded. Redlined version is required before uploading final version.” The user may respond as desired, for example, by creating a comparison document that shows redlining, uploading the redlined document, and then, if desired, uploading a final version that does not contain redlining (which would be permitted because the previous version will have contained redlining). By enforcing this technical constraint via the GUI, the underlying software platform may prevent the occurrence of human error related to the existence of multiple confusingly similar versions of the same document.

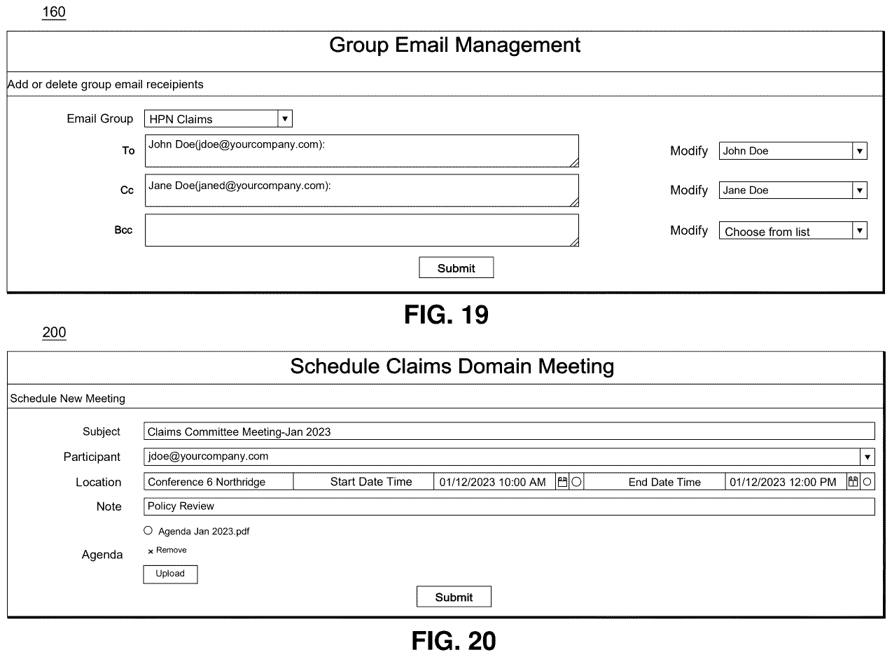

Referring again to the summary page 100 shown in FIG. 18 (or, likewise, referring back to the summary page 100 shown in FIG. 4), there may additionally be a group email button 140 for managing automated emails. For example, the software platform may be used to automatically send out notification emails in response to a new document or updated document being added to one of the domains. The recipients of a given email may, by default be all users who have access rights with respect to that particular domain, for example. By interacting with the group email button 140 (e.g., under the title bar of the document summary page 100) a user may navigate to or open a group email tool 160 as shown in FIG. 19. The group email tool 160 may be a separate page or may be displayed along with the document summary page 100 (e.g., as a popup window superimposed on the document summary page 100 or as a display pane adjacent to the document summary page 100). To manage the list of recipients in a given email group, a user may first select the email group (e.g., “HPN Claims”) from one or more selectors, e.g., from a drop-down menu as shown. (The email group may in some cases be pre-selected to correspond to the domain in which the group email button 140 was clicked.) Based on the selected email group, respective drop-down menus (labeled “Modify” in FIG. 19) for “To,” “Cc,” and “Bcc” recipient lists may be pre-loaded with the users having access to or otherwise belonging to that group. Individual users within the group may be selected using the drop-down menus or other selectors to auto-populate the lists in the “To,” “Cc,” and “Bcc” fields with corresponding email addresses. Removing recipients (and, if desired, adding recipients) may be done simply by manually editing the “To,” “Cc,” and “Bcc” fields. After making any desired changes, the user may click the “Submit” button to update the recipient lists for any future automated emails for the selected group.

FIG. 20 is a screenshot showing a schedule meeting page 200 of the GUI. The schedule meeting page 200 may be accessed from the main menu of a given domain, such as by clicking “Schedule Meeting” in the navigation popup 24 for that domain on the navigation bar 20 as shown in FIG. 3. After inputting participant email addresses and other details of the meeting (e.g., subject, location, start/end time, notes, uploaded agenda or other documents), a user may click “Submit” to send out an email to all the participants. Participants may be given an option to add the meeting to a calendar (e.g., Outlook, Google, etc.) when they receive the email. Like the document summary page 100, the schedule meeting page 200 may be substantially the same for many or all of the domains within the GUI, making it easy and intuitive for users to schedule meetings even if they are otherwise unfamiliar with the particular domain in question.

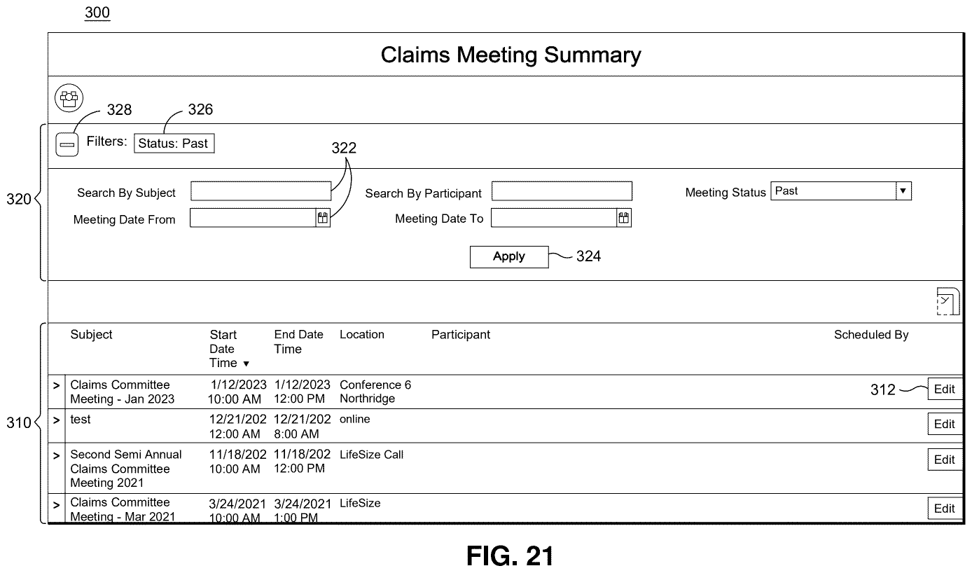

FIG. 21 is a screenshot showing a meeting summary page 300 of the GUI. Like the schedule meeting page 200, the meeting summary page 300 may be accessed from the main menu of a given domain, such as by clicking “Meeting Summary” in the navigation popup 24 for that domain on the navigation bar 20 as shown in FIG. 3. The meeting summary page 300 may have substantially the same layout and appearance as the document summary page 100 described above, making it quick and easy to learn for users of the GUI. In particular, the meeting summary page 300 may, in major part, comprise a meeting list 310 organized according to various data fields (e.g., Subject, Start Date Time, End Date Time, Location, Participant, and Scheduled By). The meeting list 310 may be arranged as a table or grid as shown and may be sortable by each data field (corresponding to the columns) and navigable using one or more slide bars, paging buttons, etc. The meeting summary page 300 may additionally comprise a filter tool 320 (e.g., above the meeting list 310) for refining the list of meetings that is displayed in the meeting list 310. Multiple filters may be applied using filter selectors 322 (e.g., Search By Subject, Search By Participant, Meeting Status, Meeting Date From, Meeting Date To), including some free entry search fields, and the currently active filters 326 may be displayed such as at the top of the filter tool 320 (“Status: Past”). As filters are applied (e.g., using an apply button 324) or removed, the meetings that appear in the meeting list 310 may be updated to include only those that meet the conditions of the active filters 326. A hide/show button 328 may be toggled to collapse or expand the filter tool 320 as needed in order to make more efficient use of limited screen real estate as described above in relation to the filter tool 120 of the document summary page 100. Like the document summary page 100 and the schedule meeting page 200, the meeting summary page 300 may be substantially the same for many or all of the domains within the GUI, making it easy and intuitive for users to review past or upcoming meetings even if they are otherwise unfamiliar with the particular domain in question.

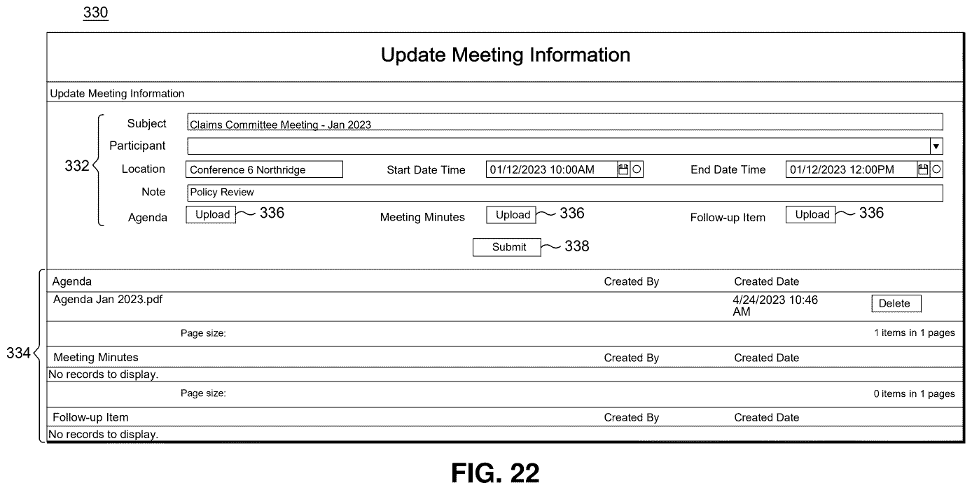

By interacting with the edit button 312 corresponding to a particular meeting displayed in the meeting list 310, a user may navigate to or open an update meeting information tool 330 as shown in FIG. 22. The update meeting information tool 330 may be a separate page or may be displayed along with the meeting summary page 300 (e.g., as a popup window superimposed on the meeting summary page 300 or as a display pane adjacent to the meeting summary page 300). Here, the user may change meeting details by editing meeting detail fields 332 (e.g., Subject, Participant, Location, Start Date/Time, End Date/Time, Note). In this example, the meeting detail fields 332 show the details of the January 2023 Claims Committee Meeting because the user clicked the edit button 312 corresponding to this meeting on the meeting summary page 300 (see FIG. 21). Below the meeting detail fields 332 is a document list 334, showing any agenda, meeting minutes, or follow-up items that are associated with the meeting. The user may delete any such documents by clicking the corresponding “Delete” button. The user may also upload new documents such as an agenda, meeting minutes, or a follow-up item by interacting with the associated upload button 336, which may open up a file selector (e.g., as a popup window, display pane, etc.) to allow the user to browse local files on his/her computing device or networked device and choose a file to be uploaded (in the same manner as the file selector 156 shown in FIG. 12). When satisfied with the content of the meeting detail fields 332 and any uploaded files, the user may interact with the submit button 338 to finalize any changes and overwrite the record of the meeting in the meeting list 310 on the meeting summary page 300 (see FIG. 21).

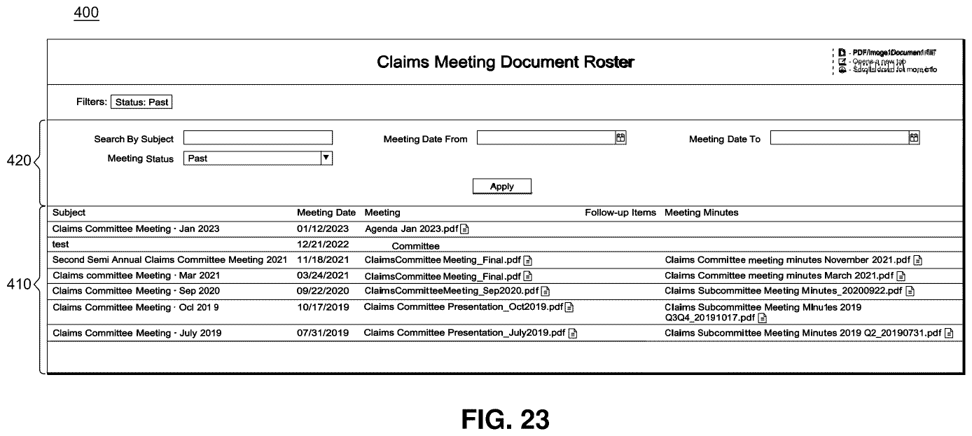

FIG. 23 is a screenshot showing a meeting document roster 400 of the GUI. Like the schedule meeting page 200 and the meeting summary page 300, the meeting document roster 400 may be accessed from the main menu of a given domain, such as by clicking “Meeting Document Roster” in the navigation popup 24 for that domain on the navigation bar 20 as shown in FIG. 3. The meeting document roster 400 may have substantially the same layout and appearance as the document summary page 100 and the meeting summary page 300 described above, making it quick and easy to learn for users of the GUI. In particular, the meeting document roster 400 may, in major part, comprise a document list 410 showing meeting documents (e.g., agendas) organized according to various data fields (e.g., Subject, Meeting Date, Meeting, Follow-up Items, and Meeting Minutes). The meeting documents in the document list 410 may be those documents that have been added by a user when creating or updating a meeting as described above. The document list 410 may be arranged as a table or grid as shown and may be sortable by each data field (corresponding to the columns) and navigable using one or more slide bars, paging buttons, etc. The user may click agendas, meeting minutes, follow-up items, and/or other entries in the document list 410 to download the document in .pdf format. The meeting document roster 400 may additionally comprise a filter tool 420 (e.g., above the document list 410) for refining the list of meeting documents that is displayed in the document list 410 in the same manner as the filter tool 320 of the meeting summary page 300. Like the document summary page 100, the schedule meeting page 200, and the meeting summary page 300, the meeting document roster 400 may be substantially the same for many or all of the domains within the GUI, making it easy and intuitive for users to review agendas and other documents associated with past or upcoming meetings even if they are otherwise unfamiliar with the particular domain in question.

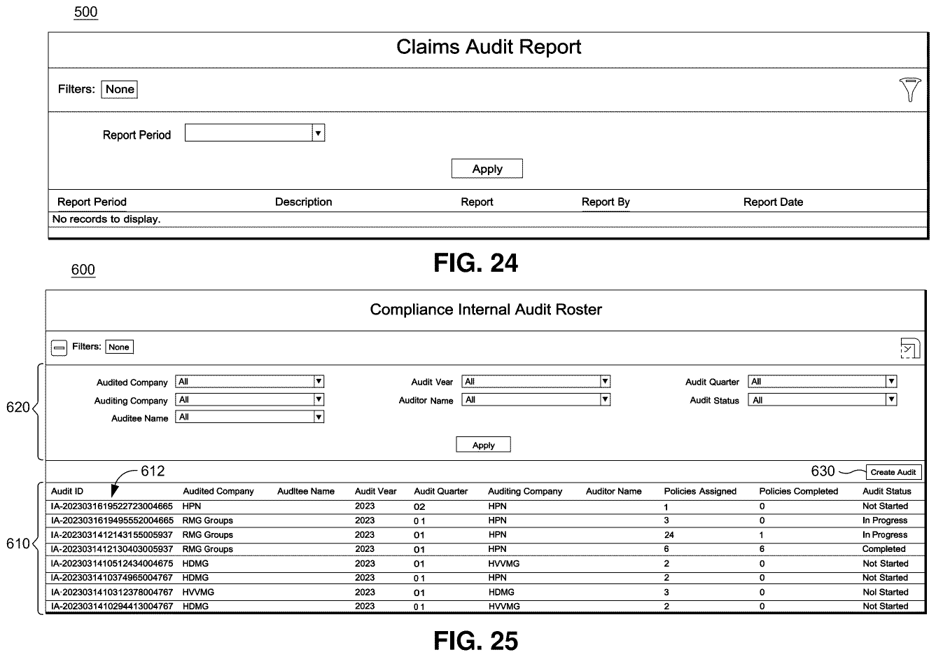

As explained above, the various pages and tools of the GUI may be identical or similar across different domains, advantageously reducing the learning curve and the likelihood of human error for new users. The GUI may additionally have pages that are unique to particular domains. For example, within the context of a managed care organization, a Claims domain may provide the ability to record results and address corrective action plans from health plan audits. To this end, the GUI may include a claims audit report page 500 as shown in FIG. 24, which may be reached by selecting “Audit Report” in the navigation popup 24 for the Claims domain on the navigation bar 20. The GUI may provide additional functionality in relation to audits within the Compliance domain, such as a compliance internal audit roster 600 as shown in FIG. 25, which may be reached by selecting “Internal Audit Tool” in the navigation popup 24 for the Compliance domain on the navigation bar 20. The compliance internal audit roster 600 may capture the status and results of internal audits and may have substantially the same layout and appearance as the document summary page 100, the meeting summary page 300, and the meeting document roster 400 described above, making it quick and easy to learn for users of the GUI. The compliance internal audit roster 600 may, in major part, comprise an audit list 610 of audit records 612 (listed by Audit ID) organized according to various data fields (e.g., Audited Company, Auditee Name, Audit Year, Audit Quarter, Auditing Company, Auditor Name, Policies Assigned, Policies Completed, and Audit Status). The audit list 610 may be arranged as a table or grid as shown and may be sortable by each data field (corresponding to the columns) and navigable using one or more slide bars, paging buttons, etc. The compliance internal audit roster 600 may additionally comprise a filter tool 620 (e.g., above the audit list 610) for refining the list of audit records 612 that is displayed in the audit list 610 in the same manner as the filter tool 320 of the meeting summary page 300 or the filter tool 420 of the meeting document roster 400.

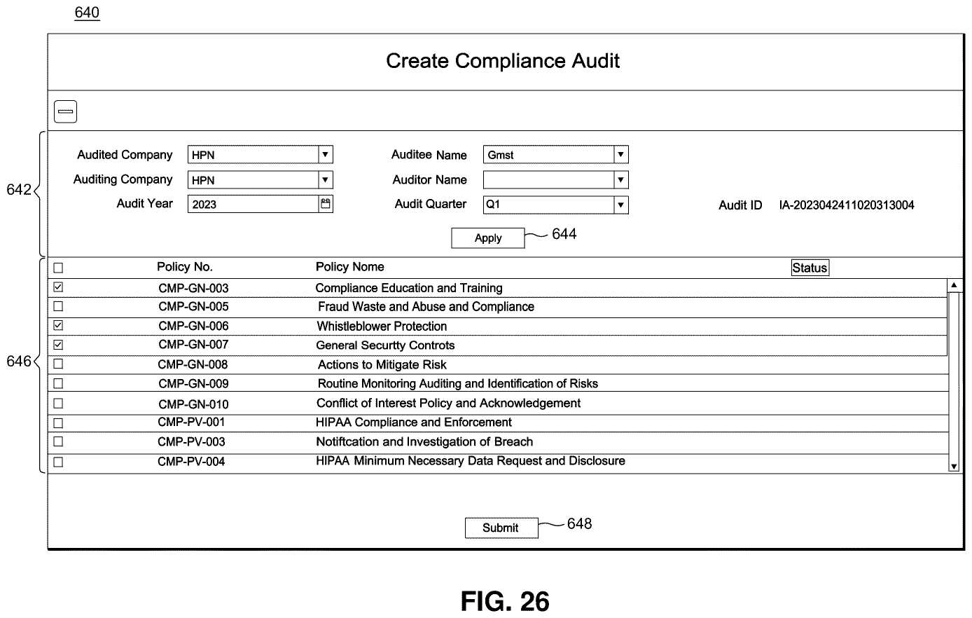

To add a new audit record 612, a user may click the create audit button 630 to navigate to a create compliance audit page 640 as shown in FIG. 26. Using audit information selectors 642, the user may provide the details of the new audit record (e.g., Audited Company, Auditee Name, Auditing Company, Auditor Name, Audit Year, and Audit Quarter). The software platform may automatically assign a new Audit ID as shown. When the user interacts with the apply button 644, the information input using the audit information selectors 642 may be associated with the new audit record being created. The user may then check or otherwise select the policy or policies that are to be reviewed from among the policies listed in the policy list 646 and click the submit button 648 when finished. The new audit record 612 will now appear on the compliance internal audit roster 600 (see FIG. 25) among the audit records 612 displayed in the audit list 610. Upon creation of the new audit record 612, the Audit Status may indicate “Not Started.”

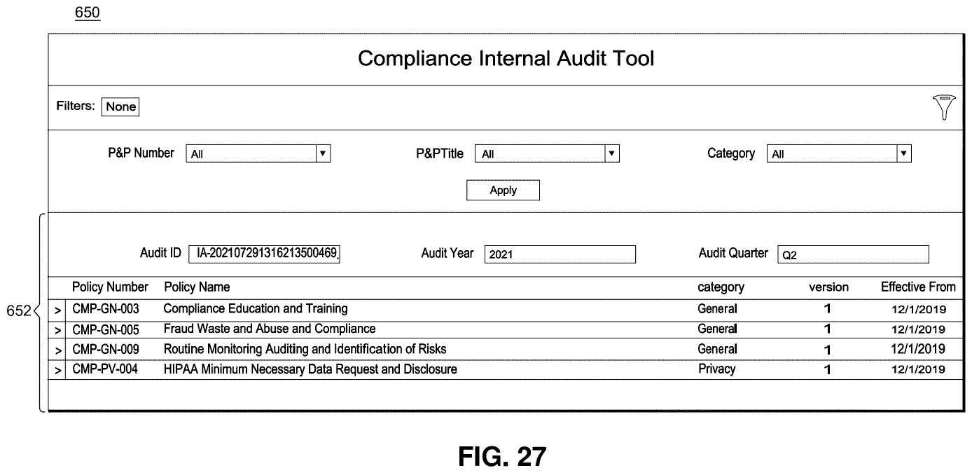

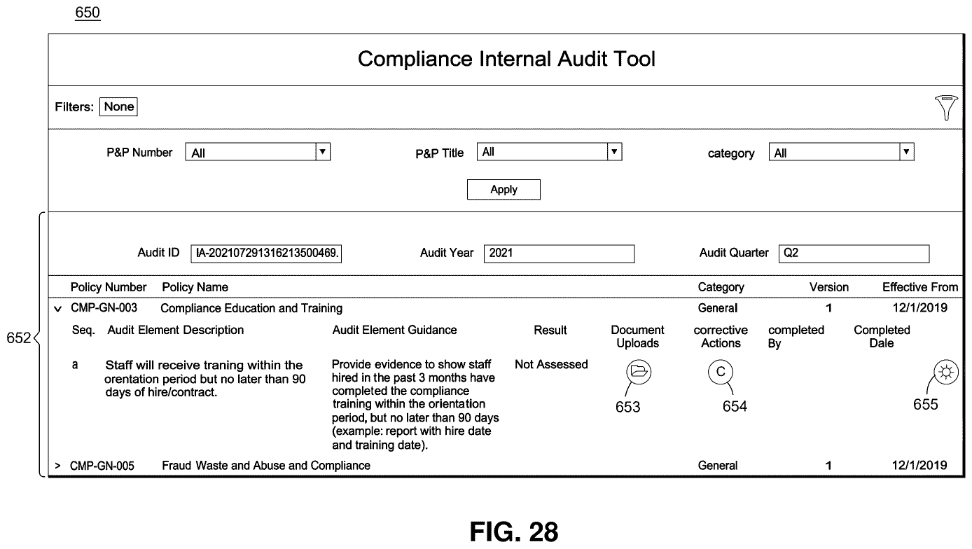

When a user clicks one of the audit records 612 in the audit list 610 (see FIG. 25), the user may navigate to or open a compliance internal audit tool 650 as shown in FIGS. 27 and 28. The compliance internal audit tool 650 may be a separate page or may be displayed along with the compliance internal audit roster 600 (e.g., as a superimposed popup window or an adjacent display pane). The compliance internal audit tool 650 may display a policy list 652 that lists the policies that were reviewed during the audit whose audit record 612 was selected by the user. The policy list 652 may be arranged as a table or grid as shown and may be sortable by each data field (corresponding to the columns) and navigable using one or more slide bars, paging buttons, etc. (The compliance internal audit roster 600 may additionally comprise a filter tool as described in relation to other pages of the GUI.) By clicking the carrot (“>”) at the lefthand side of a given entry in the policy list 652, the user may expand the entry as shown in FIG. 28. In addition to the policy number, policy name, category, version, and effective date that was previously visible, the expanded entry in the policy list 652 may further show the progress and details of the audit of that policy, including descriptions and guidance associated with the elements of the audit as well as any results that have been assessed and a series of transaction buttons, e.g., a document upload button 653, a corrective actions button 654, and an edit result field button 655.

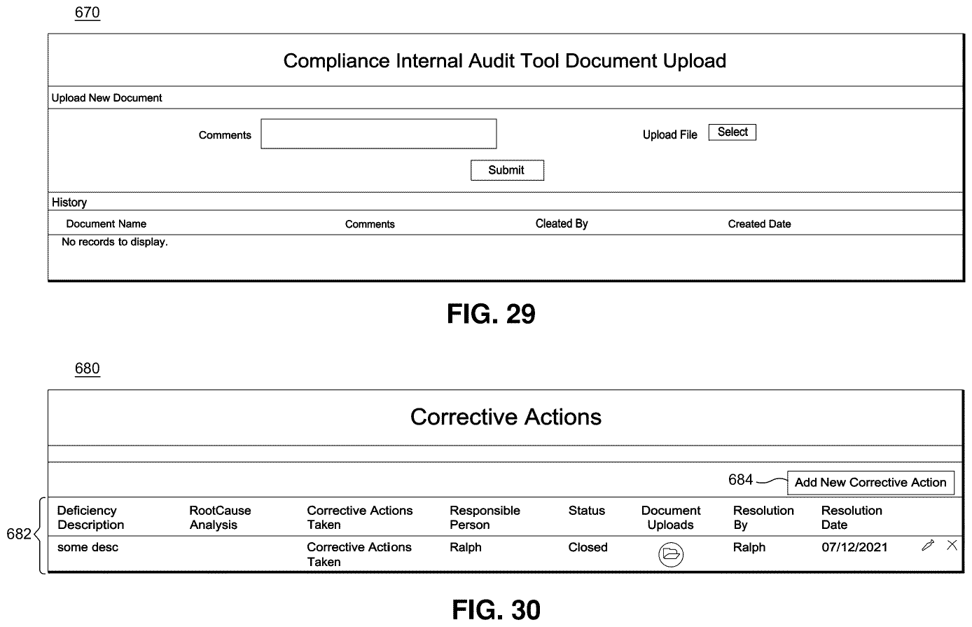

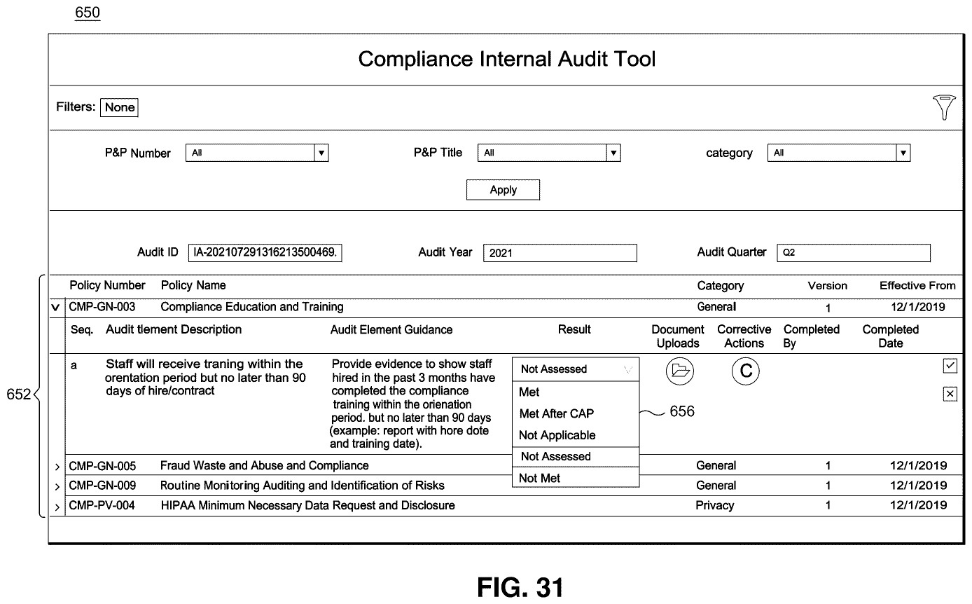

The document upload button 653 may open a compliance internal audit document upload tool 670 as shown in FIG. 29, which may function in the same way as the other document upload tools described herein. Any uploaded documents may be attached to the audit in question. The corrective actions button 654 may open a corrective actions tool 680 as shown in FIG. 30, displaying a list of corrective actions that have been taken in relation to the audit. These may be listed in a corrective actions list 682 organized according to various data fields (e.g., Deficiency Description, RootCause Analysis, Corrective Actions Taken, Responsible Person, Status, Document Uploads, Resolution By, and Resolution Date). The compliance internal audit document upload tool 670 and the corrective actions tool 680 may be separate pages from the compliance internal audit tool 650 or may be displayed alongside it (e.g., as a popup window or display pane). The edit result field button 655 may enable the Result field on the compliance internal audit tool 650 as shown in FIG. 31, allowing the user to change the status of the audit element using a result field selector 656 such as a picklist or dropdown menu.

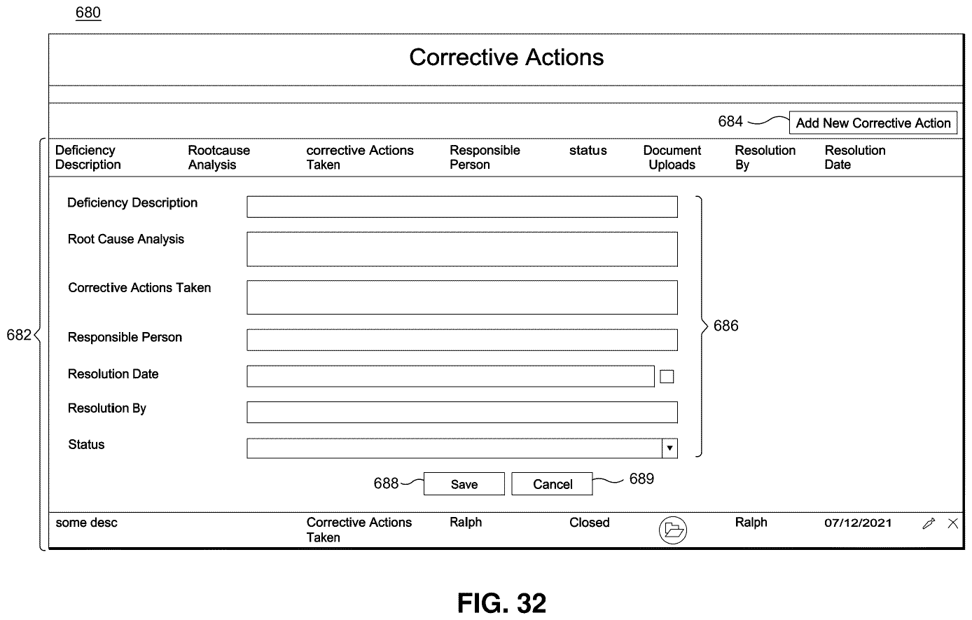

FIG. 32 is another screenshot of the corrective actions tool 680. Upon first navigating to the corrective actions tool 680 using the corrective actions button 654 (see FIG. 28), the corrective actions tool 680 may appear as it does in FIG. 30, comprising mainly the corrective actions list 682. When the user clicks the add new corrective action button 684, the corrective actions tool 680 may expand as shown in FIG. 32 to include a plurality of data fields 686 for entry of a new corrective action in the corrective actions list 682. After entering the information of the new corrective action into the data fields 686, the user may click the save button 688 to create a new entry in the corrective actions list 682. The corrective actions list 682, including the new entry, may be viewed at a later time by again clicking the corrective action button 654 associated with the particular policy of interest in the policy list 652 (see FIG. 28). If the user wishes to end the creation of the new corrective action, the user may instead click the cancel button 689.

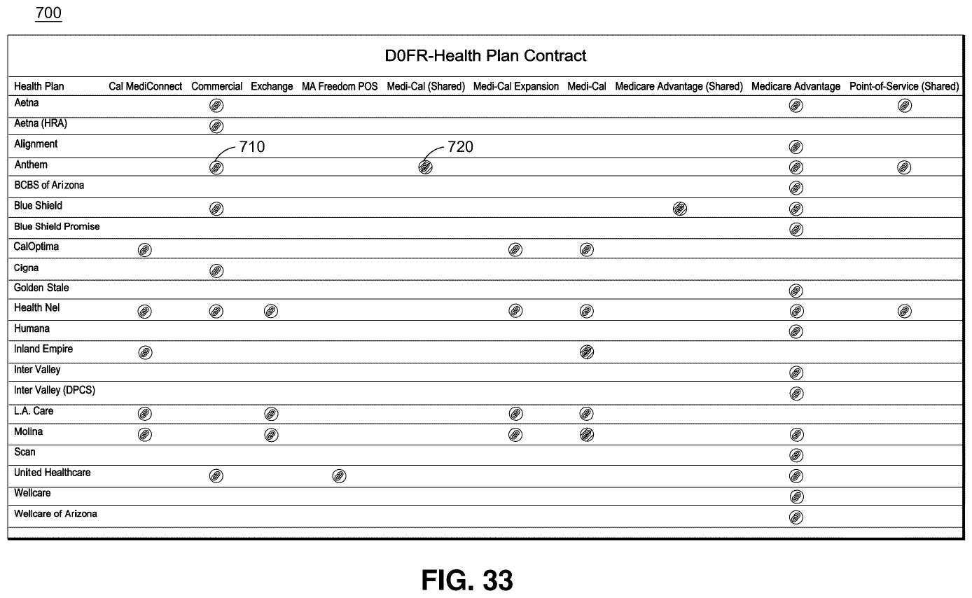

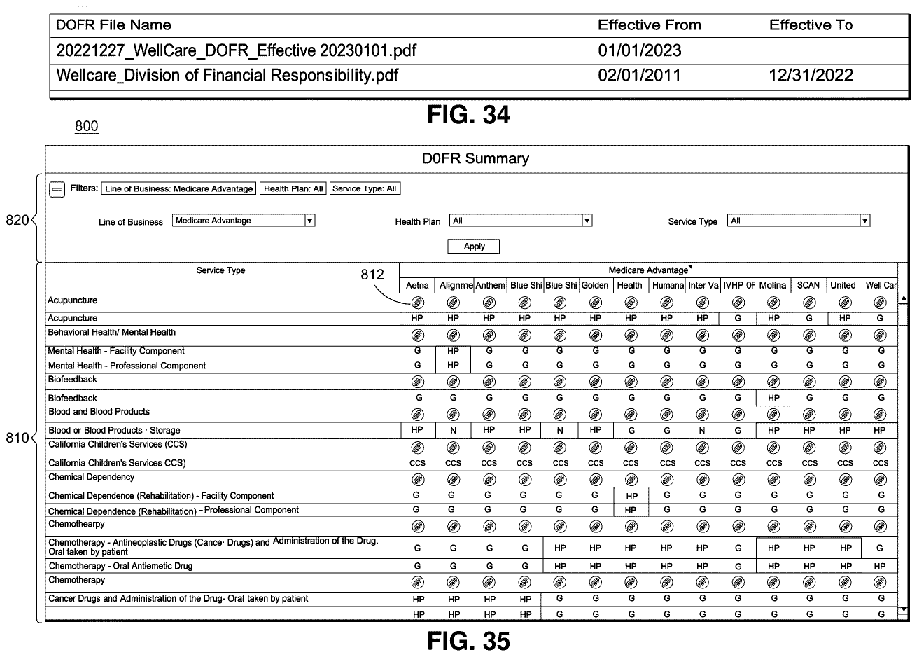

In a managed care organization, a Division of Financial Responsibility (DOFR) is an agreement between a group of providers and a health plan that outlines the financial obligation between each party. The agreement may also be referred to as a health plan contract. The Health Plan Contract domain of the GUI may be used to store DOFRs and related information. A user may navigate to the Health Plan Contract domain using the corresponding navigation button 12, 24 on the navigation page 10 or navigation bar 20 (see FIG. 1). For example, choosing “DOFR Health Plan Contract” from the main menu of the Health Plan Contract domain may open a DOFR health plan contract page 700 as shown in FIG. 33. The DOFR health plan contract page may display all the health plan DOFRs according to health plan and line of business. A user may click on a link 710 of a first color (e.g., blue) to open the actual DOFR documents (e.g., in .pdf format). Links 720 of a second color (e.g., red, represented with hatch pattern) may indicate that there are termed DOFRs available. When a user clicks on a link 720, the GUI may open a termed DOFR selector 730 as shown in FIG. 34 (e.g., as a popup window), allowing the user to choose between different versions of the DOFR (which can then be opened in .pdf format by clicking the file name).

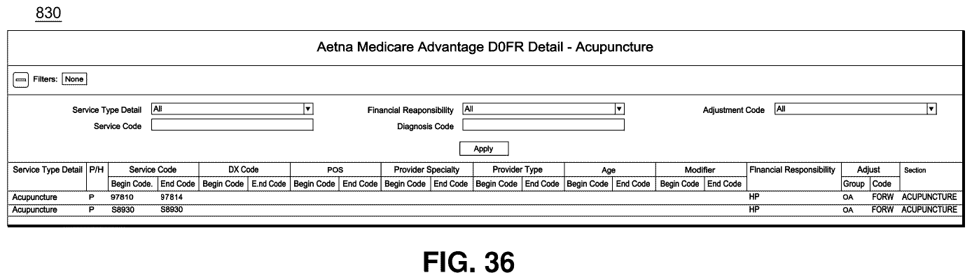

Choosing “DOFR Summary” from the main menu of the Health Plan Contract domain may open a DOFR summary page 800 as shown in FIG. 35. The DOFR summary page 800 displays financial responsibility by health plan and service type in a selected line of business and may comprise a DOFR summary 810 and a filter tool 820 (for filtering by line of business, health plan, and service type, for example). By mousing over the line of business in the DOFR summary 810 (e.g., “Medicare Advantage”), the GUI may display a description of codes (e.g., as a popup window), such as G (group responsibility), HP (health plan responsibility), N (not covered), etc. By clicking one of the DOFR detail buttons 812, a DOFR detail view 830 may be displayed as shown in FIG. 36, where the user may see a list of service codes for that category.

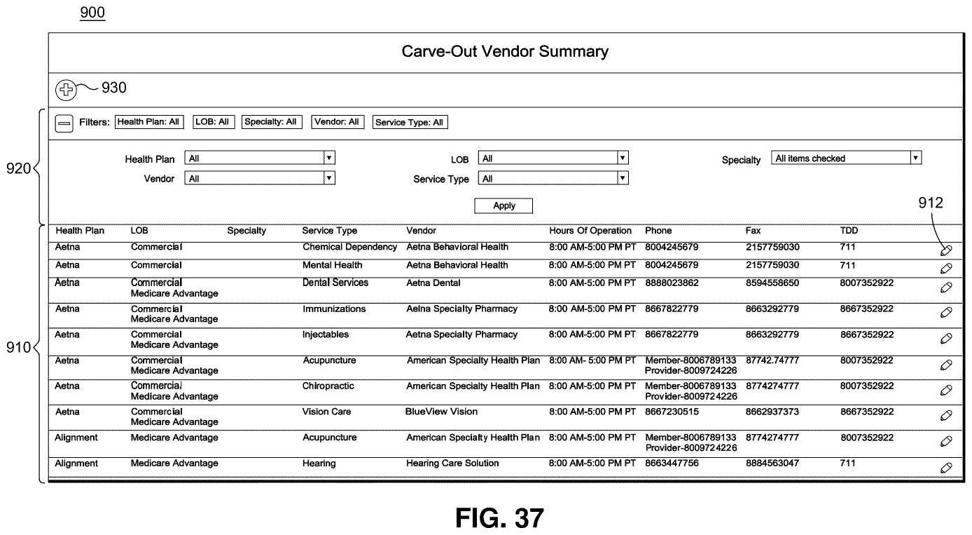

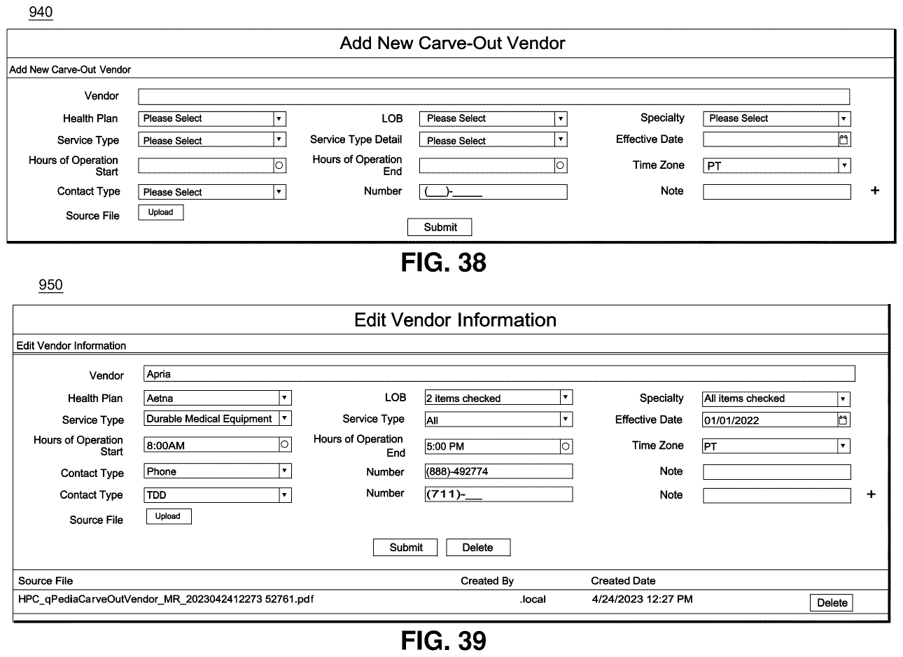

Choosing “Carve-Out Vendor Summary” from the main menu of the Health Plan Contract domain may open a carve-out vendor summary page 900 as shown in FIG. 37. Based on the DOFR, the group may not be financially responsible for services that are carved out by the health plan to third-party vendors. The carve-out vendor summary page 900 maintains the carve-out vendor information by health plan, line of business, and service type and may comprise a carve-out vendor list 910 and filter tool 920. In order to add a new record, a user may click on a new record button 930 to open a new carve-out vendor tool 940 as shown in FIG. 38 (as a popup window, display pane, etc.) The user may provide vendor information along with source files, such as emails or documents, that contain original vendor information, and may save the record by clicking “Submit.” FIG. 39 shows an edit vendor information tool 950 that may be used to edit or delete an existing carve-out vendor record. To open the edit vendor information tool 950, the user may click an edit vendor information button 912 corresponding to the selected carve-out vendor on the carve-out vendor summary page 900. It is noted that access to the edit function may be granted only to users who maintain the carve-out vendor information. As such, a user without edit access (e.g., as determined from a user profile associated with the user's login credentials) may receive an error message when clicking the edit vendor information button 912.

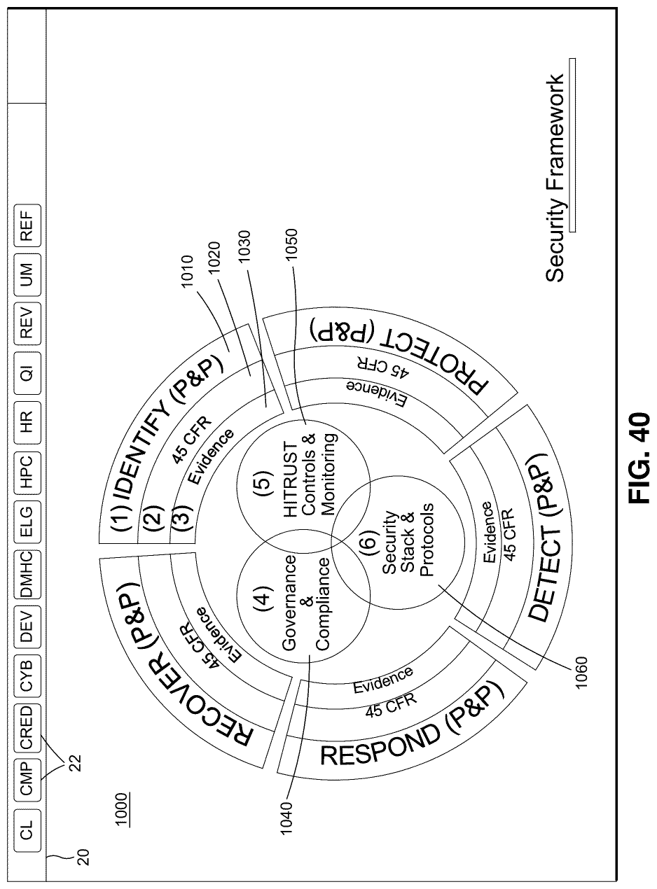

FIG. 40 is a screenshot showing a cybersecurity framework page 1000 of the GUI, which may be accessed using the corresponding navigation button 12, 24 on the navigation page 10 or navigation bar 20 (see FIG. 1). The cybersecurity framework page 1000 may conveniently organize the structure and operations of the Cybersecurity domain according to the National Institute of Standards and Technology (NIST) framework. In general, the framework may be organized into five key functions—Identify, Protect, Detect, Respond, Recover. These terms, when considered together, provide a comprehensive view of the lifecycle for managing cybersecurity risk over time. Each function contains detailed categories/sub-categories of information, mapping to 45 Code of Federal Regulations (CFR) as well as mapping to cybersecurity and compliance policies & procedures. As shown, the GUI elements for access pages associated with each function may be organized into three layers: an outer layer including a cybersecurity function button 1010 that takes the user to a cybersecurity function categories page 1100 for that function, a middle layer including a cybersecurity regulations button 1020 that takes the user to a cybersecurity regulations page 1200 for that function, and an inner layer including a cybersecurity evidence button 1030 that takes the user to a cybersecurity evidence page 1300 for that function. The layers may be laid out as a ring in which the five cybersecurity functions are arranged circumferentially. Advantageously, the cybersecurity function categories page 1100, the cybersecurity regulations page 1200, and the cybersecurity evidence page 1300 may be substantially the same for many or all of the cybersecurity functions (Identify, Protect, Detect, Respond, and Recover), making the cybersecurity framework page 1000 and its various subpages easy and intuitive for users even if they are otherwise unfamiliar with the particular cybersecurity function in question.

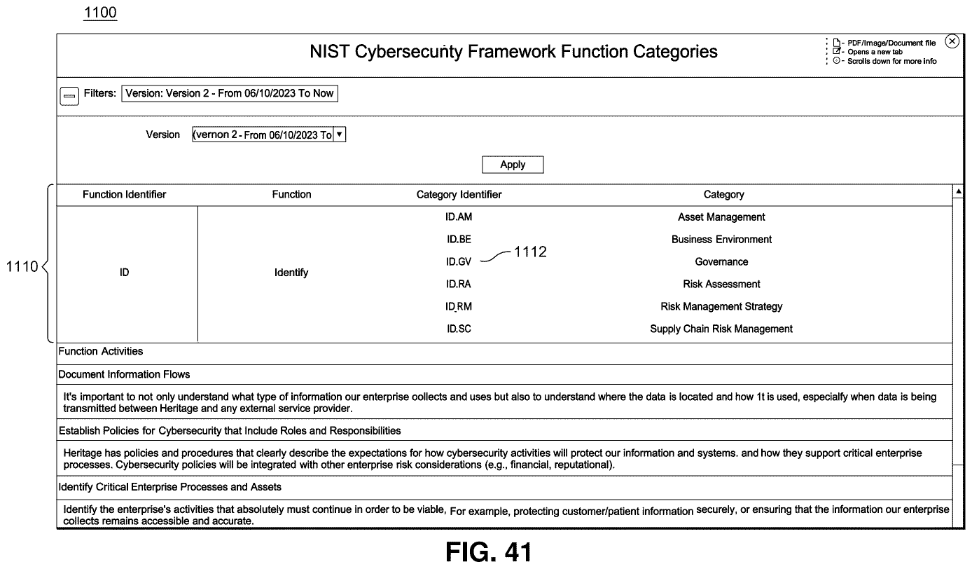

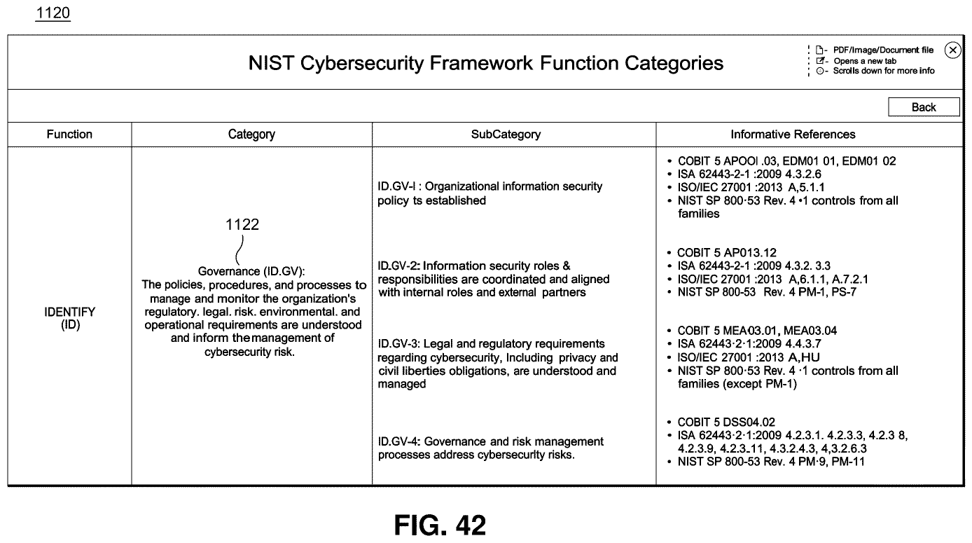

FIG. 41 is a screenshot showing the cybersecurity function categories page 1100, which may be accessed using the cybersecurity function button 1010 associated with a particular cybersecurity function as described above. The cybersecurity function categories page 1100 may show the function's categories and activities. In the illustrated example, a user has clicked the cybersecurity function button 1010 of the Identify function, so the cybersecurity function categories page 1100 shows a category listing 1110 of categories (Asset Management, Business Environment, etc.) and their identifiers (ID.AM, ID.BE, etc.) that pertain to the Identify function. Below the category listing, the function's activities are displayed, detailing recommended steps that will help provide a comprehensive view of the lifecycle for managing cybersecurity risk. By clicking on one of the categories or its identifier (e.g., ID.GV in the illustrated example), the user may navigate to the corresponding category details page 1120 as shown in FIG. 42, which may provide details regarding the category, sub-category, and related informative references for that particular category. From this page (e.g., by clicking on the category 1122), the user may open the relevant Policy & Procedure document in .pdf format, such as a Cybersecurity Identify-Governance Policy & procedure document.

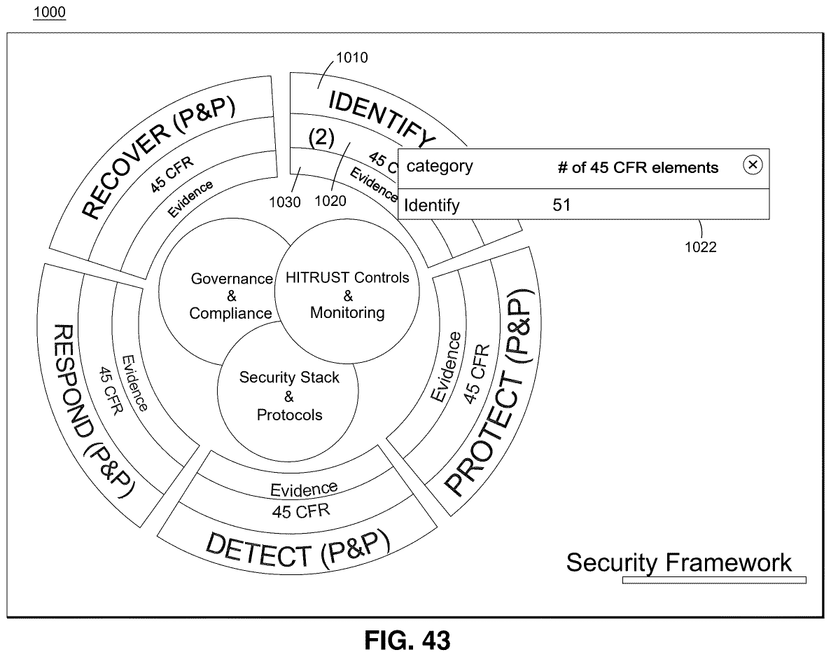

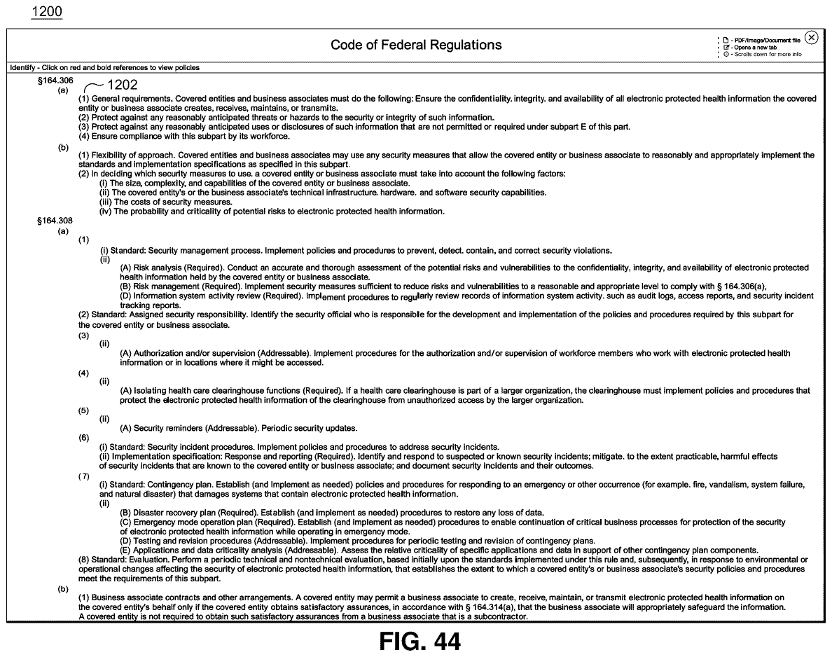

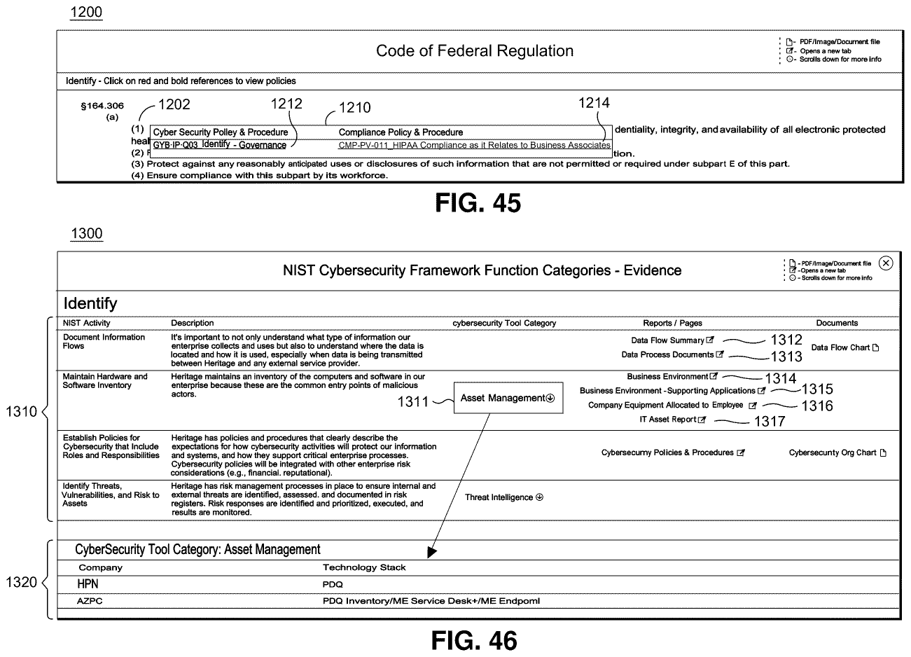

Referring to FIG. 43, the user may click on the cybersecurity regulations button 45 (i.e., the 45 CFR ring) of a particular cybersecurity function on the cybersecurity framework page 1000 to open a navigation popup 1022 containing the category and number of elements. When selected, the user may then navigate to the regulations page 1200 as shown in FIG. 44. On the cybersecurity regulations page 1200, the user may be immediately navigated to the particular regulations related to the cybersecurity function in question, in this case Identify. A regulation 1202 may be clicked to open a pop-up 1210 as shown in FIG. 45, which may contain respective hyperlinks 1212, 1214 to associated Cybersecurity Policy & Procedure documents and Compliance Policy & Procedure documents for the function in question.

FIG. 46 is a screenshot of a cybersecurity evidence page 1300 of the GUI, which may be accessed using the cybersecurity function button 1030 associated with a particular cybersecurity function (e.g., Identify) as described above. The cybersecurity evidence page 1300 may display a list 1310 of NIST activities, along with related tool categories and subcategories, reports, and document links. The legend in the upper righthand corner may describe how each document will be opened. Under the Cybersecurity Tool Category column, the user may click a hyperlink 1311 for a particular category (e.g., asset management) to open a corresponding list 1320 of tools as shown. In this case, as indicated by the legend, the hyperlink 1311 allows the user to access the list 1320 by scrolling down on the same page.

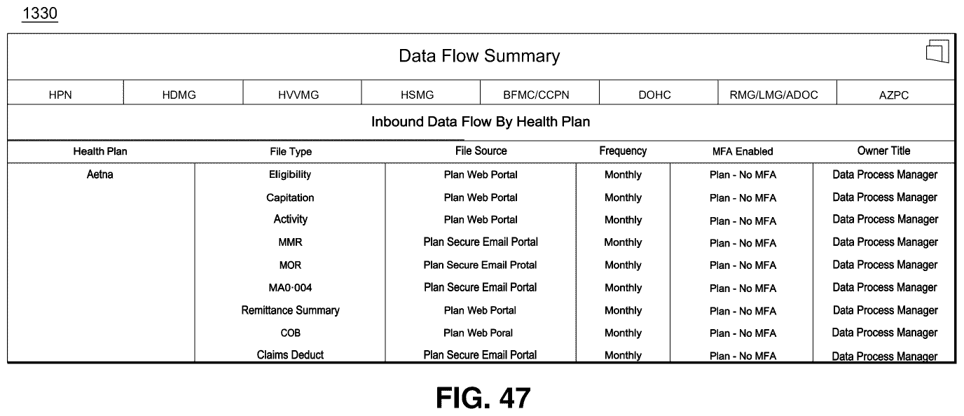

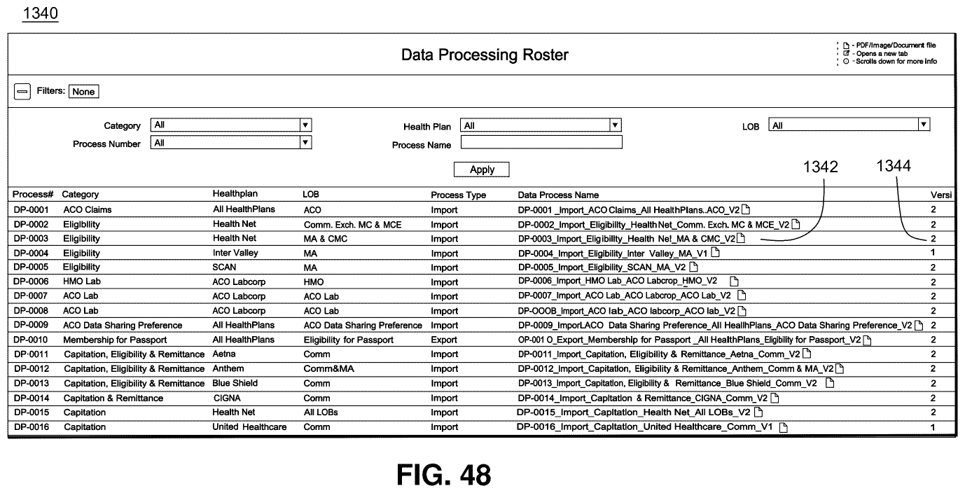

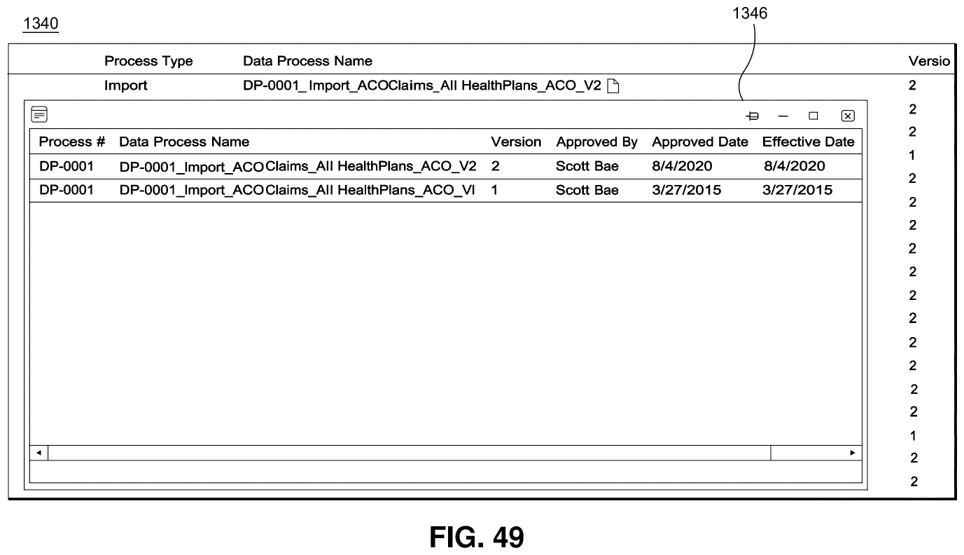

Under the Reports/Pages column various hyperlinks may be provided to open new tabs, display panes, or popup windows showing the selected information. For example, reports and pages associated with the Document Information Flows activity of the Identify function may include a data flow summary page 1330 as shown in FIG. 47 (accessible using the data flow summary link 1312 on the cybersecurity evidence page 1300) and a data processing roster 1340 as shown in FIG. 48 (accessible using the data process documents link 1313). Referring to FIG. 47, the data flow summary page 1330 may include a top bar of tabs breaking down the data by each group. The GUI may provide an option to download the data as a spreadsheet table. Referring to FIG. 48, the data processing roster 1340 may include a grid (with corresponding filter tool) listing all processes for downloading data files related to eligibility, capitation, etc. from a Health Plan or Centers for Medicare and Medicaid Services (CMS), as well as where the data is stored. The user may click on a process link 1342 to display a given desktop procedure and may click on a version link 1344 to see a list 1346 of any earlier documents (e.g., as a popup window) as shown in FIG. 49. Documents may be viewed, printed, and/or downloaded in .pdf format.

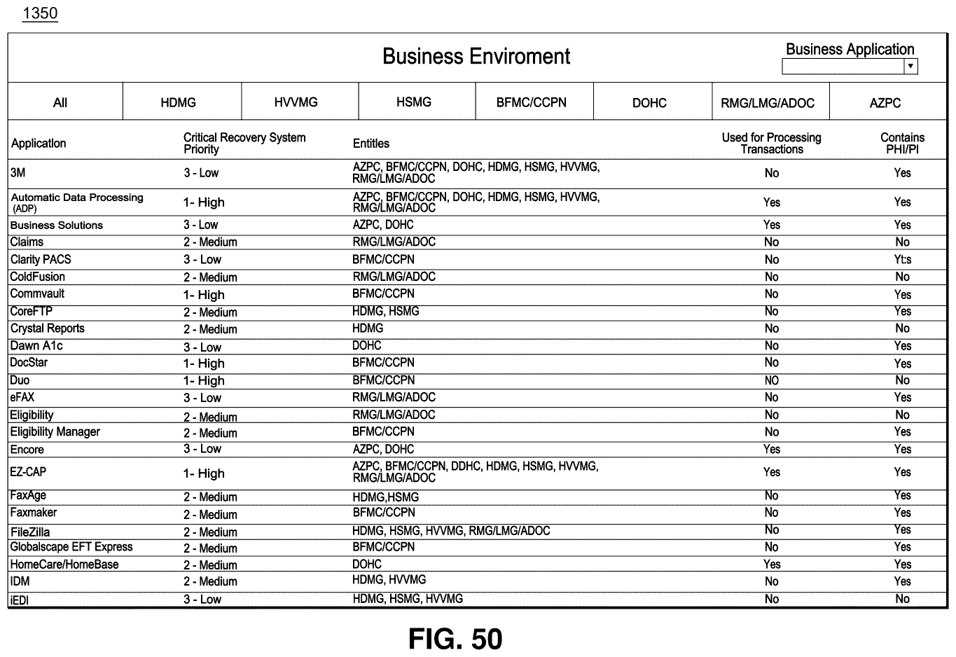

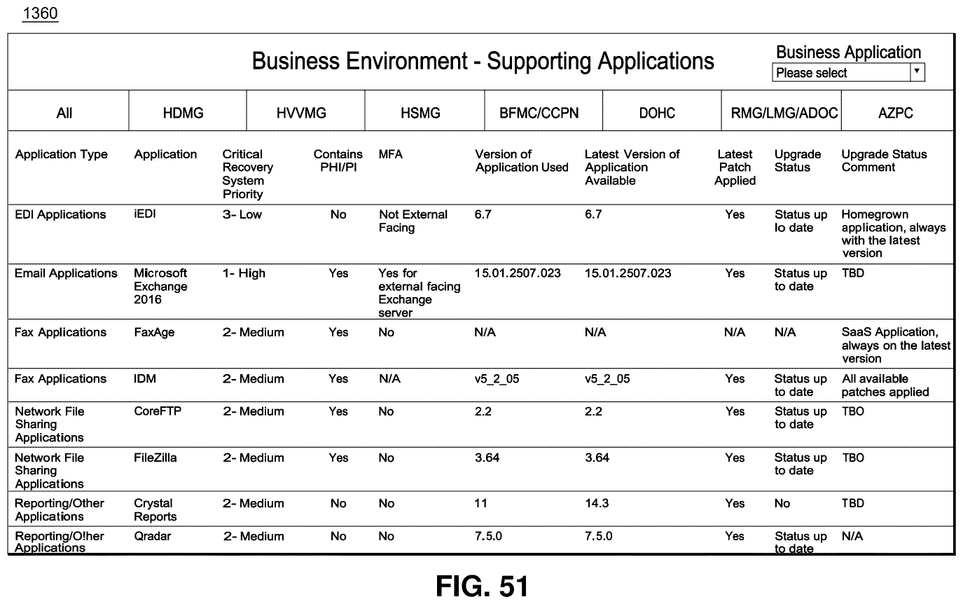

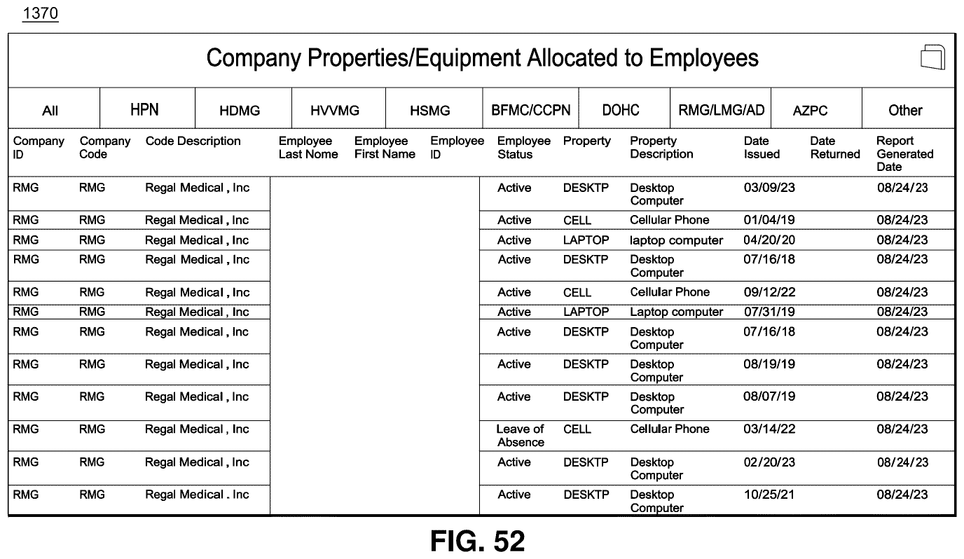

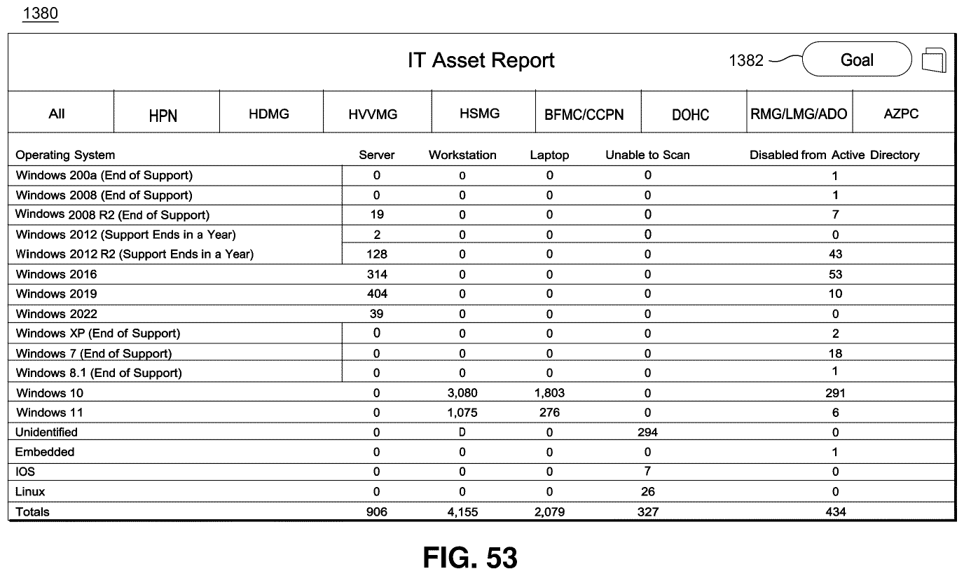

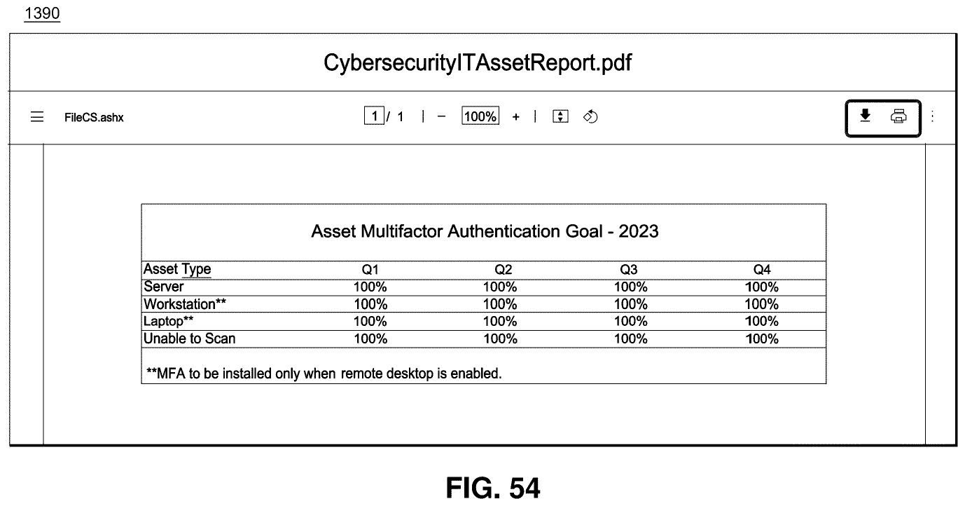

Reports and pages associated with the Maintain Hardware and Software Inventory activity of the Identify function may include a business environment page 1350 that lists critical business applications for each group as shown in FIG. 50 (accessible using the business environment link 1314 on the cybersecurity evidence page 1300), a business environment supporting applications page 1360 that lists other supporting applications related to mail, fax, automail, SFTP, etc. used during the course of business as shown in FIG. 51 (accessible using the business environment supporting applications link 1315), a company equipment page 1370 that shows company-owned devices and other assets that have been allocated, distributed, or assigned to each employee as shown in FIG. 52 (accessible using the company equipment link 1316), and an IT asset report page 1380 that displays a complete list of all IT assets comprising computers, servers, and laptops broken down by group as shown in FIG. 53 (accessible using the IT asset report link 1317). By clicking on the goal button 1382 of the IT asset report page 1380, the user may see a display 1390 showing the current state of reaching a goal associated with the report as shown in FIG. 54 (such as a multifactor authentication goal). Any of the various lists and displays of information may be downloaded as a spreadsheet table.

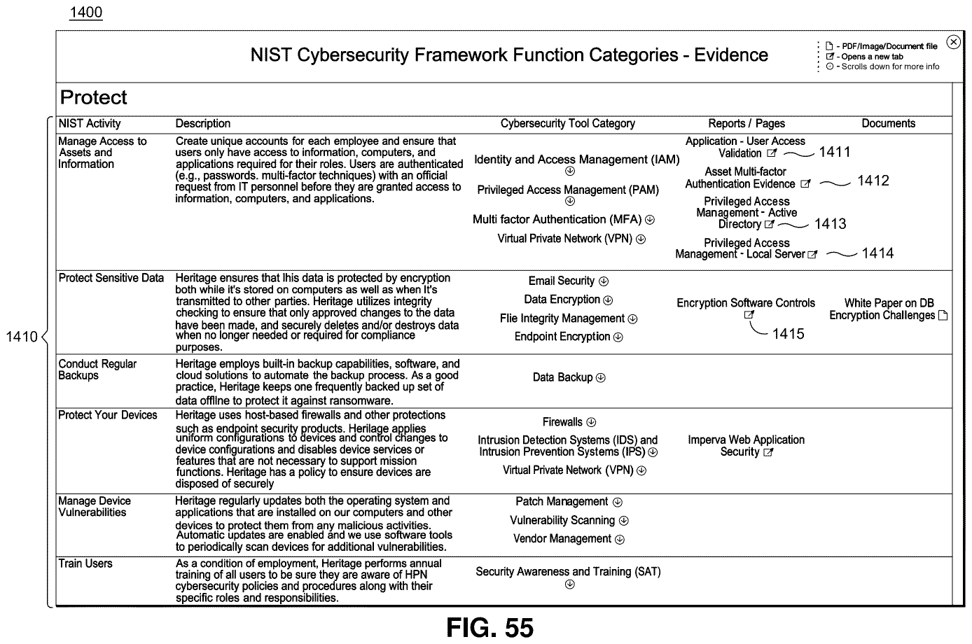

FIG. 55 is a screenshot of another cybersecurity evidence page 1400 of the GUI, which may be accessed using the cybersecurity function button 1030 associated with another cybersecurity function, in this case Protect. Just like the cybersecurity evidence page 1300 for the Identify function, the cybersecurity evidence page 1400 for the Protect function may display a list 1410 of NIST activities, along with related tool categories and subcategories, reports, and document links. The legend in the upper righthand corner may similarly describe how each document will be opened. Items under the Cybersecurity Tool Category column and the Report/Pages column of the cybersecurity evidence page 1400 may operate in the same way as described above in relation to the cybersecurity evidence page 1300.

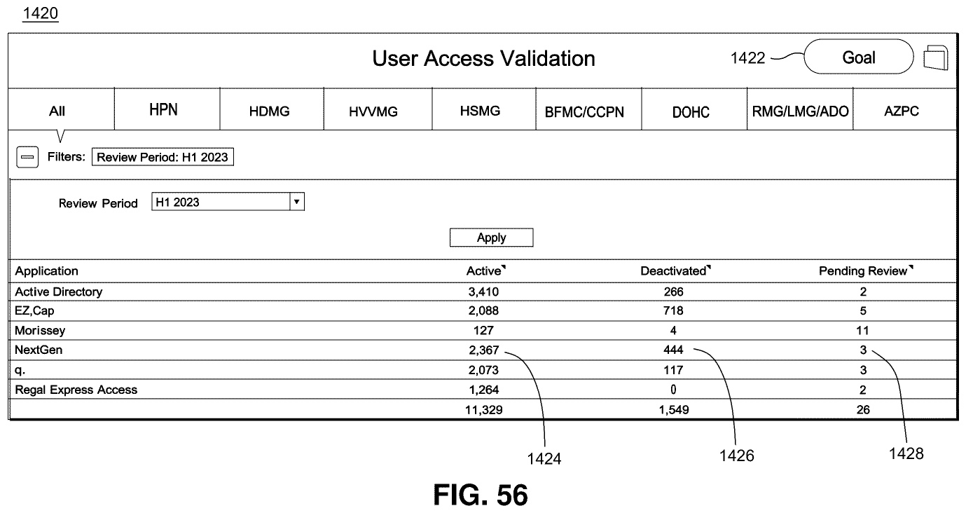

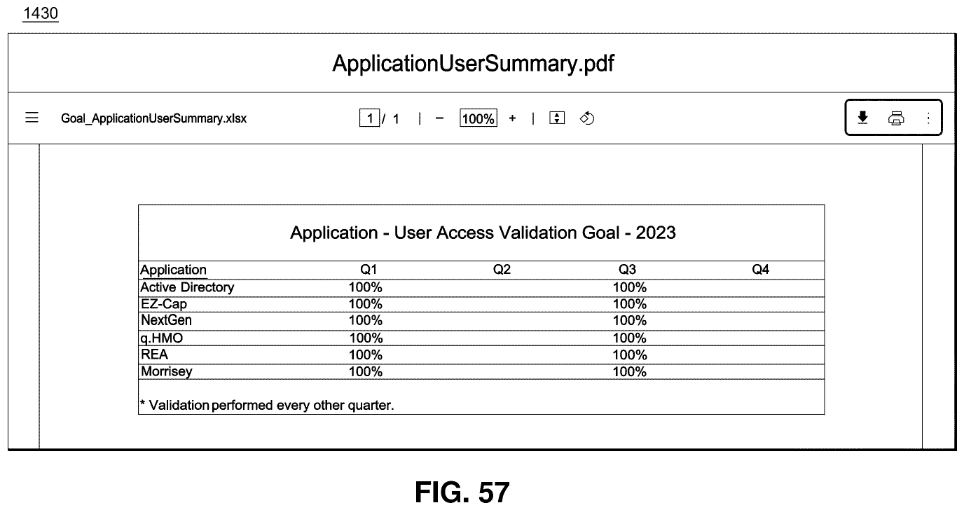

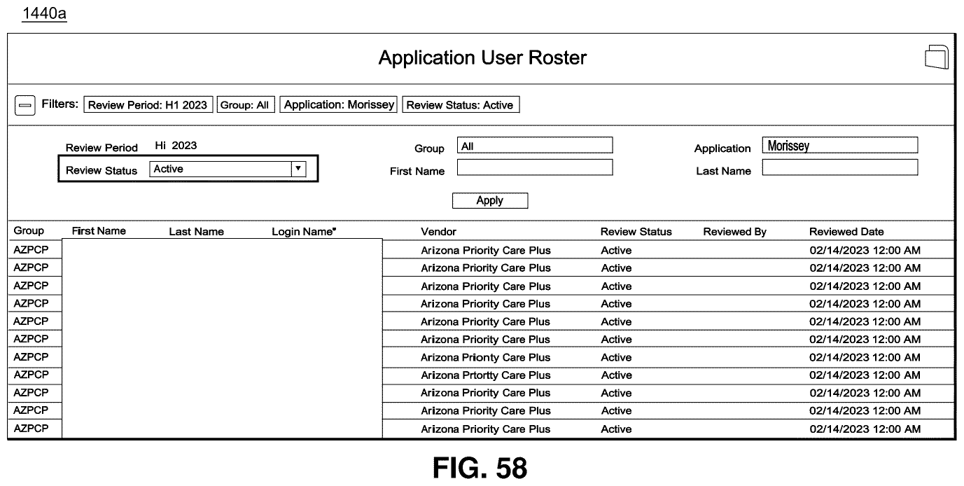

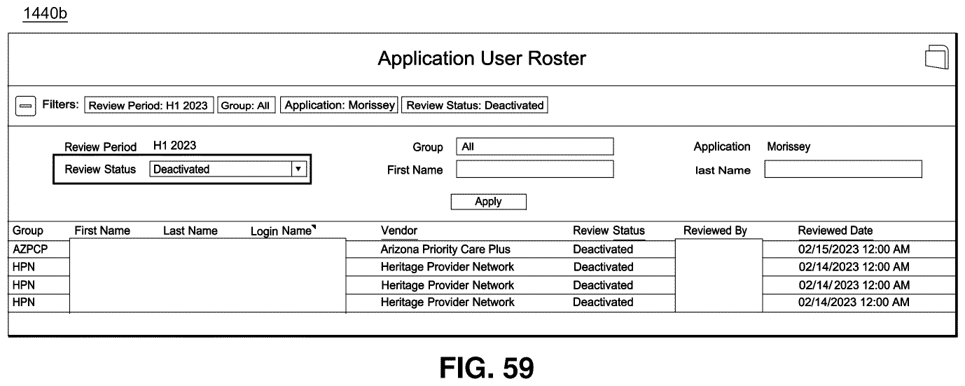

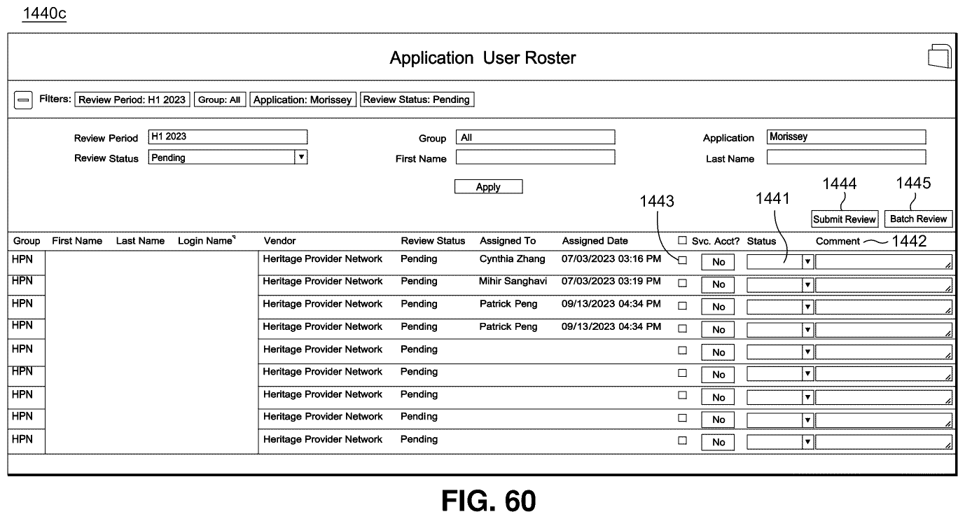

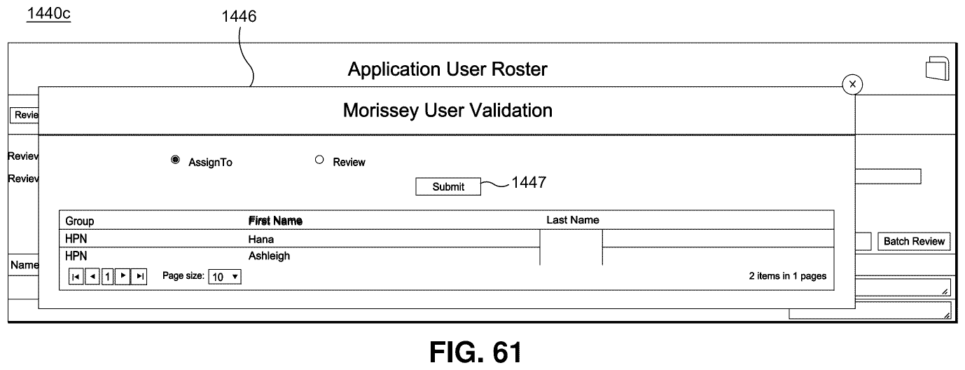

Reports and pages associated with the Manage Access to Assets and Information activity of the Protect function may include a user access validation page 1420 that shows users who have been validated to use each application as shown in FIG. 56 (accessible using the user access validation link 1411 on the cybersecurity evidence page 1400). By clicking on the goal button 1422 of the user access validation page 1420, the user may see a display 1430 as shown in FIG. 57, showing the current state of reaching a goal associated with the report (such as a user access validation goal). Under each column on the user access validation page 1420, a user may click on a value to see a list of employees who are currently active, deactivated, or pending review. The list may be sorted by application, and the user may also select a provider group by clicking on a tab and/or filter by review period. More specifically, clicking on a value 1424 in the Active column may display an application user roster 1440a of those users who are currently validated as shown in FIG. 58, clicking on a value 1426 in the Deactivated column may display an application user roster 1440b of those users who are currently not activated (e.g., have been unvalidated) as shown in FIG. 59, and clicking on a value 1428 in the Pending Review column may display an application user roster 1440c of those users who are currently pending review as shown in FIG. 60. Referring to FIG. 60, when a user's status is pending, the user may process the user's status to either active or deactivated. To do this, the user may select the appropriate status (e.g., active, deactivated, or pending) from a dropdown menu 1441, add any relevant comment (e.g., “Okay to activate”) in a comments field 1442, check the user's checkbox 1443, click the submit review button 1444. The user will be removed from this list and moved to the appropriate roster 1440a or 1440b. In the case of processing multiple user's statuses at a time, the user may check multiple checkboxes 1443 and click the batch review button 1445. In this case, a confirmation popup 1446 may be displayed as shown in FIG. 61, and the user may click the submit button 1447 if satisfied with the names displayed.

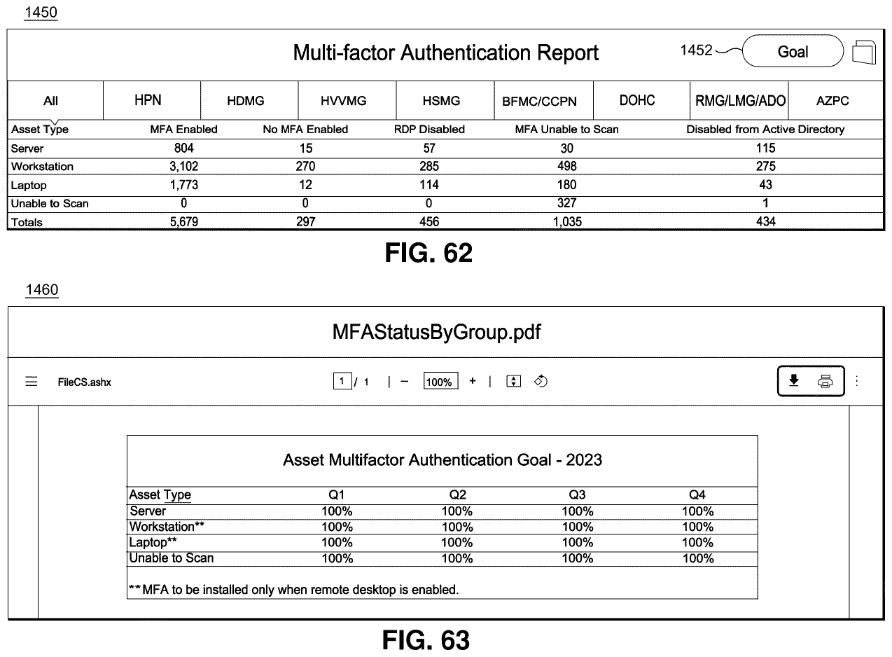

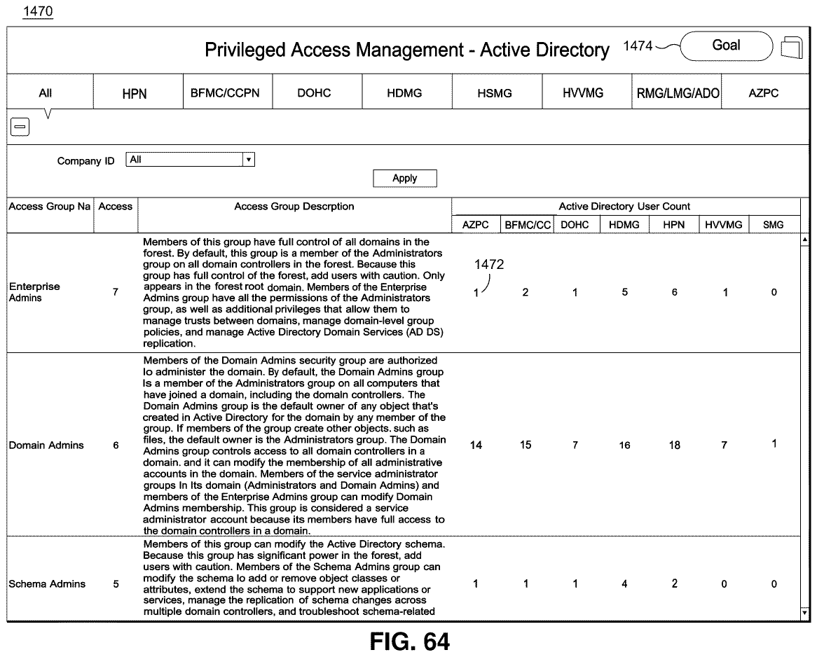

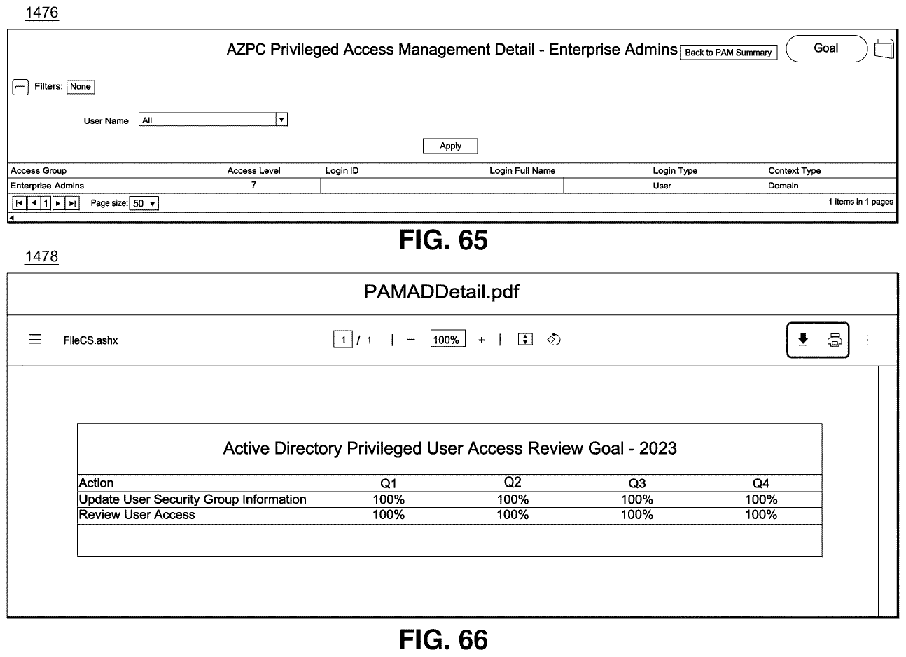

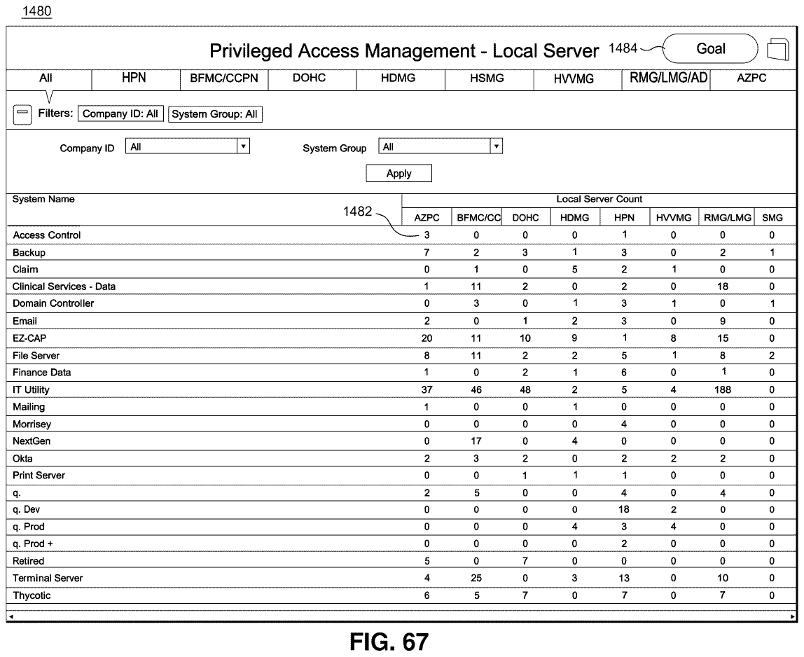

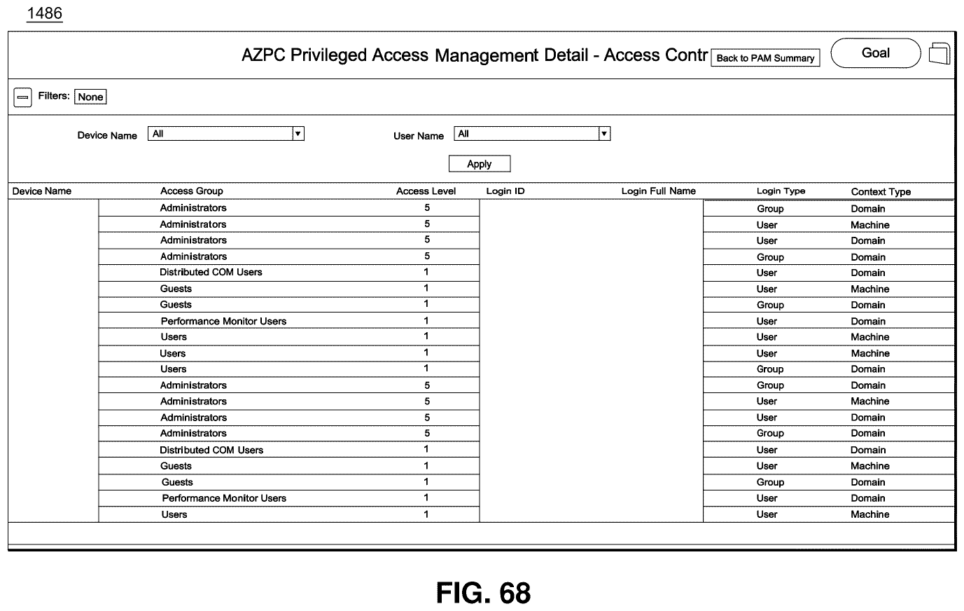

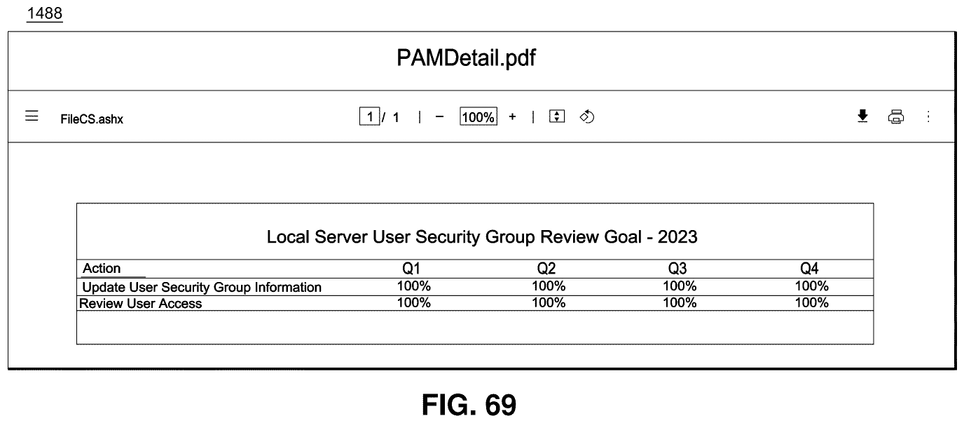

Referring back to FIG. 55, further reports and pages associated with the Manage Access to Assets and Information activity of the Protect function may include a multi-factor authentication report page 1450 that displays a list of devices that have multi-factor authentication (MFA) enabled as shown in FIG. 62 (accessible using the multifactor authentication report link 1412 on the cybersecurity evidence page 1400). By clicking on the goal button 1452 of the multi-factor authentication report page 1450, the user may see a display 1460 as shown in FIG. 63, showing the current state of reaching a goal associated with the report (such as a multifactor authentication goal). The reports and pages associated with the Manage Access to Assets and Information activity of the Protect function may further include a privileged access management active directory page 1470 that displays a list of users with privileged access in the active directory and their levels of access as shown in FIG. 64 (accessible using the privileged access management active directory link 1413 on the cybersecurity evidence page 1400). Clicking on a user count 1472 may open a privileged access management detail view 1476 showing the respective group, name of the grouping, login ID, and login type for each user as shown in FIG. 65. By clicking on the goal button 1474 of the privileged access management active directory page 1470, the user may see a display 1478 as shown in FIG. 66, showing the current state of reaching a goal associated with the report (such as an active directory privileged user access review goal). The reports and pages associated with the Manage Access to Assets and Information activity of the Protect function may further include a privileged access management local server page 1480 that displays a list of users with privileged access in the local server and their levels of access as shown in FIG. 67 (accessible using the privileged access management local server link 1414 on the cybersecurity evidence page 1400). Clicking on a user count 1482 may open a privileged access management detail view 1486 showing the device name, access group, login ID, and login type for each user as shown in FIG. 68. By clicking on the goal button 1484 of the privileged access management local server page 1480, the user may see a display 1488 as shown in FIG. 69, showing the current state of reaching a goal associated with the report (such as a local server user security group review goal).

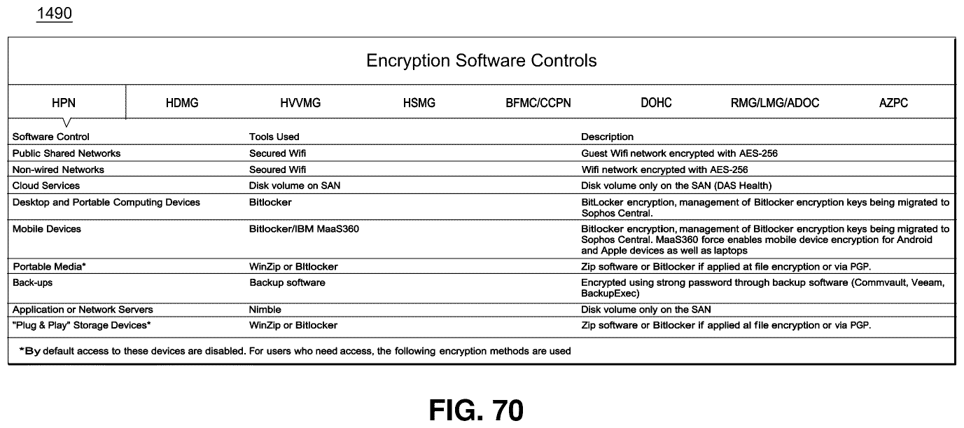

Reports and pages associated with the Protect Sensitive Data activity of the Protect function may include an encryption software controls page 1490 that lists device types and networks that have been encrypted as shown in FIG. 70 (accessible using the encryption software controls link 1415 on the cybersecurity evidence page 1400). Any of the various lists and displays of information described in relation to the subpages of the cybersecurity evidence page 1400 may be downloaded as a spreadsheet table. As should be appreciated, whether the user is working in the Identity function or the Protect function of the cybersecurity framework, the cybersecurity evidence page 1300, 1400 (as well as many of its subpages) may have substantially the same layout and appearance, increasing usability of the GUI and reducing the likelihood of human error.

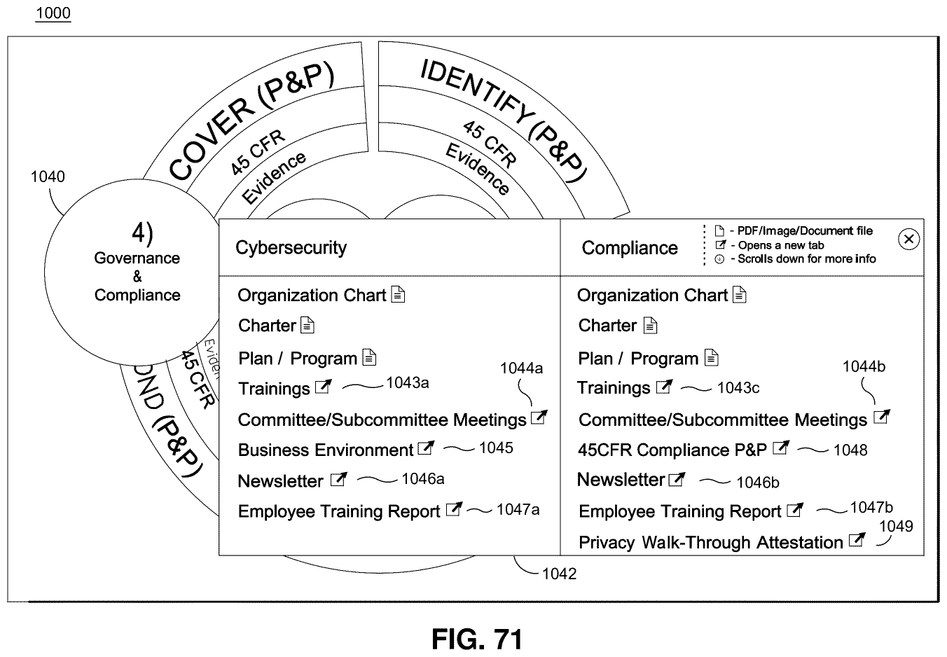

Referring again to the cybersecurity framework page 1000 of FIG. 40, there may additionally be a governance and compliance button 1040 for overview and management of cybersecurity and compliance programs, a Health Information Trust Alliance (HITRUST) controls and monitoring button 1050 for vulnerability screening, proactive threat detection, and incident response, and a security stack and protocols button 1060 for accessing a summary of the technology stack used by all groups for each cybersecurity domain and tool category (including drill down to a group to show implementation status). These buttons 1040, 1050, 1060 may be placed in the center of the ring in which the five cybersecurity functions (Identify, Protect, Detect, Respond, Recover) are arranged, as these features may not be specifically associated with any one of the individual cybersecurity functions. As shown in FIG. 71, when a user clicks on the governance and compliance button 1040, a governance and compliance popup 1042 may be displayed allowing the user to navigate to the following components under the cybersecurity column: organization chart, charter, plan/program, trainings, committee/subcommittee meetings, business environment, newsletter, and employee training report. Clicking on the Organization Chart, Charter, or Plan/Program link will display a downloadable .pdf document of a cybersecurity organization chart (showing current committee members and titles/responsibilities), the current committee charter, or the current cybersecurity plan, respectively.

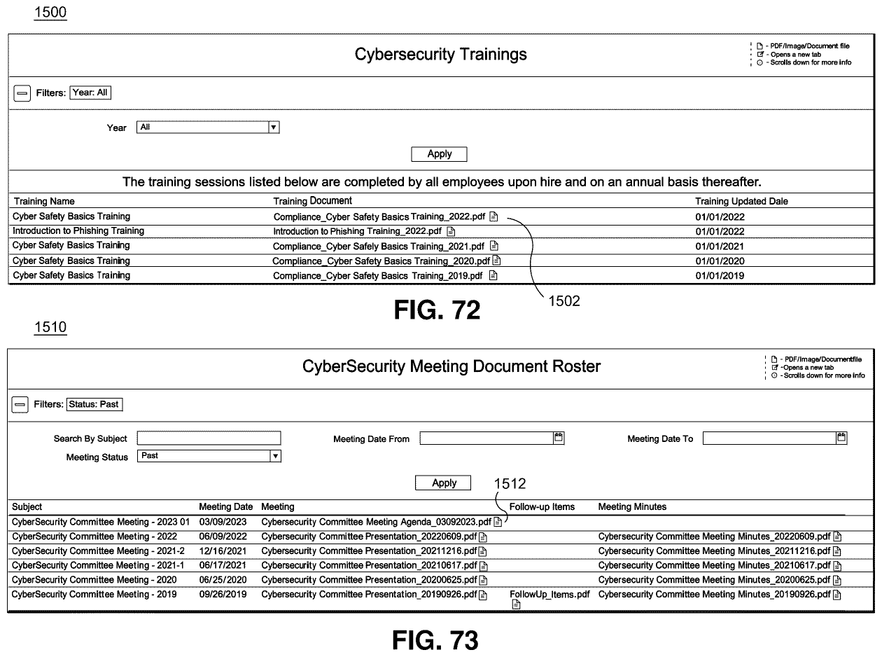

FIG. 72 is a screenshot of a cybersecurity trainings page 1500 of the GUI (which may be accessed using the cybersecurity trainings link 1043a shown in FIG. 71). The cybersecurity trainings page 1500 may display a list of training programs that have been developed for a specific area and may include a filter tool for filtering the list (e.g., by year). Clicking on a link 1502 corresponding to a given training document may display a description of that training program in .pdf format. FIG. 73 is a screenshot of a cybersecurity meeting document roster 1510 of the GUI (which may be accessed using the cybersecurity committee/subcommittee meetings link 1044a shown in FIG. 71). The cybersecurity meeting document roster 1510 may display a list of past meetings with their agendas, meeting minutes, and follow-up items. Clicking on a link 1512 corresponding to a given document may display the document in .pdf format. Advantageously, the cybersecurity trainings page 1500 and cybersecurity meeting document roster 1510 may have substantially the same layout, appearance, and functionality as each other and as other pages of the GUI (such as the meeting document roster 400 described in relation to FIG. 23, above), improving usability thereof.

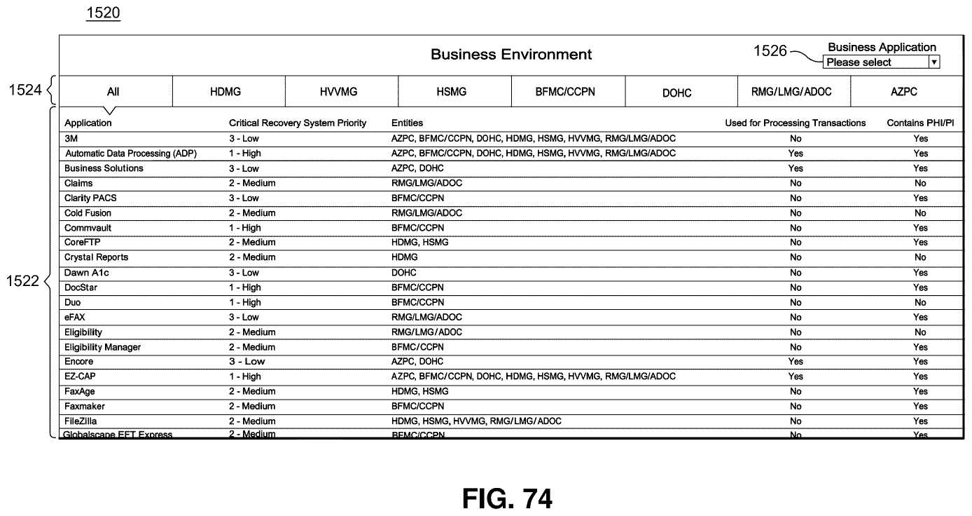

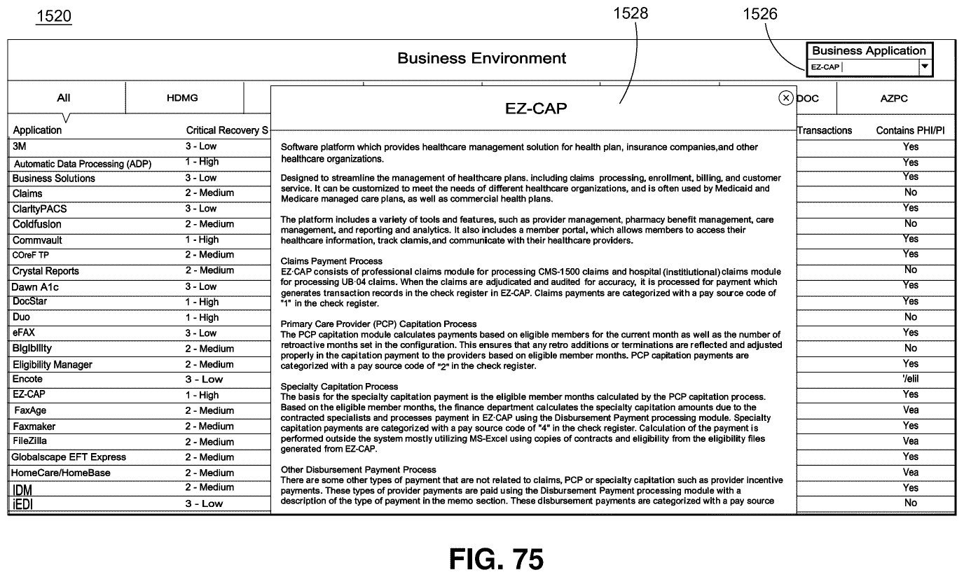

FIG. 74 is a screenshot of a cybersecurity business environment page 1520 of the GUI (which may be accessed using the business environment link 1045 shown in FIG. 71). The business environment page 1520 may include a list 1522 of applications in association with critical recovery system priorities, entities, and other information. The user may choose a group (or “All”) from the top menu 1524 to filter the list 1522. The user may also select a particular application using the dropdown menu 1526. As shown in FIG. 75, when an application (e.g., EZ-CAP) is selected using the dropdown menu 1526, the GUI may display a popup window 1528 with an explanation of what the application does.

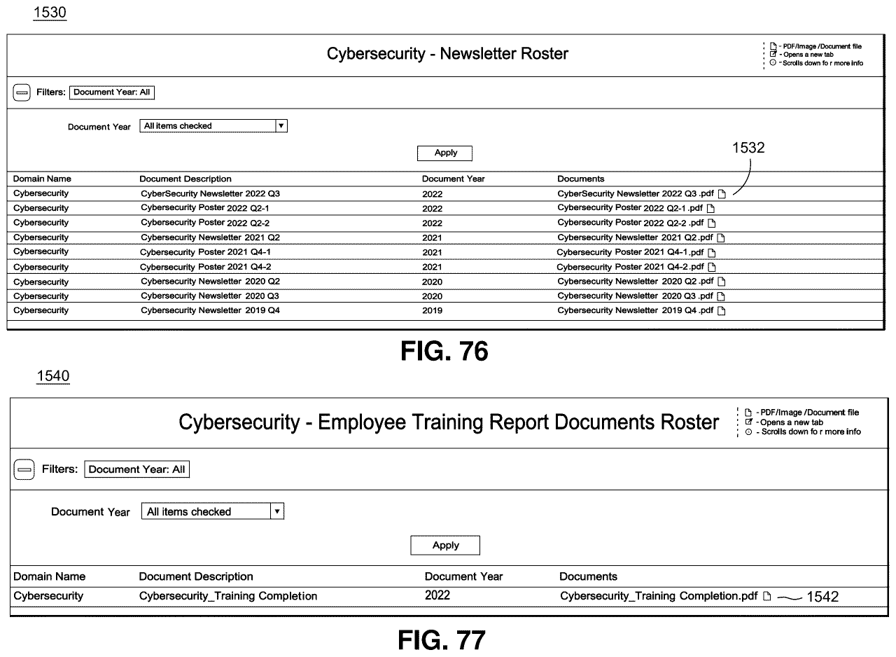

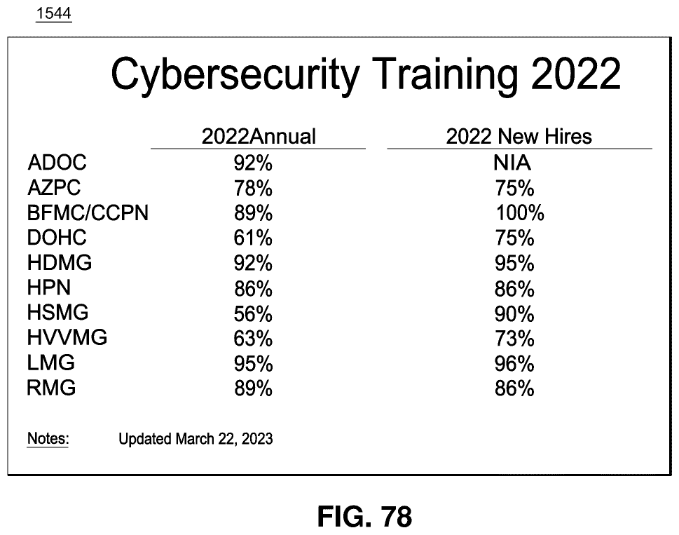

FIG. 76 is a screenshot of a cybersecurity newsletter roster 1530 of the GUI (which may be accessed using the newsletter link 1046a shown in FIG. 71). The cybersecurity newsletter roster 1530 may display a list of past newsletters, which can be filtered by year. By clicking on link 1532, a user may access the associated newsletter in .pdf format. FIG. 77 is a screenshot of a cybersecurity employee training report roster 1540 of the GUI (which may be accessed using the employee training report link 1047a shown in FIG. 71). The cybersecurity employee training report roster 1540 may display a list of past training sessions, which can be filtered by year. By clicking on a link 1542, a user may access the associated training document in .pdf format. A report 1544 showing the results of a selected training session may be sorted by group as shown in FIG. 78.

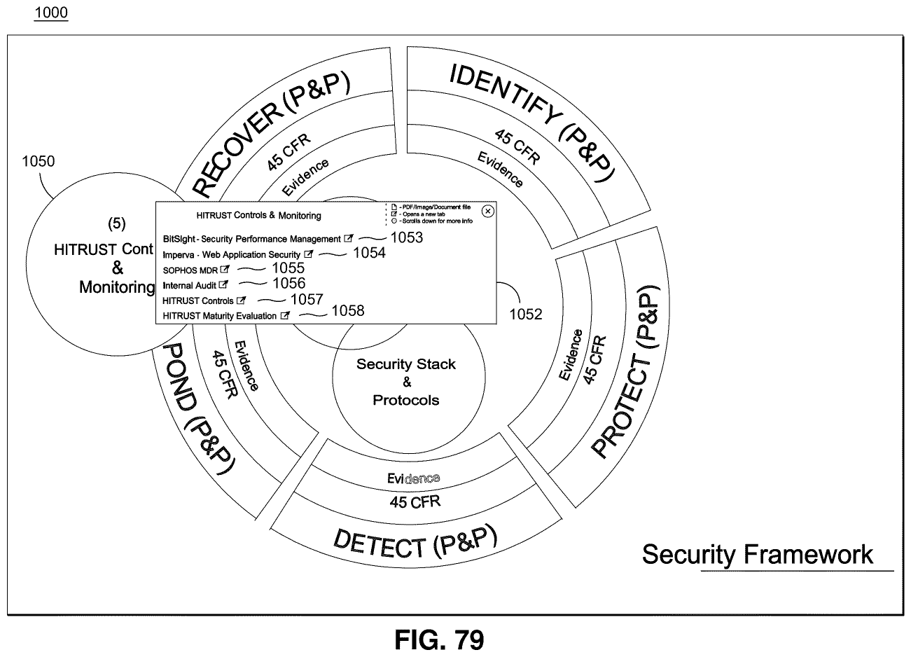

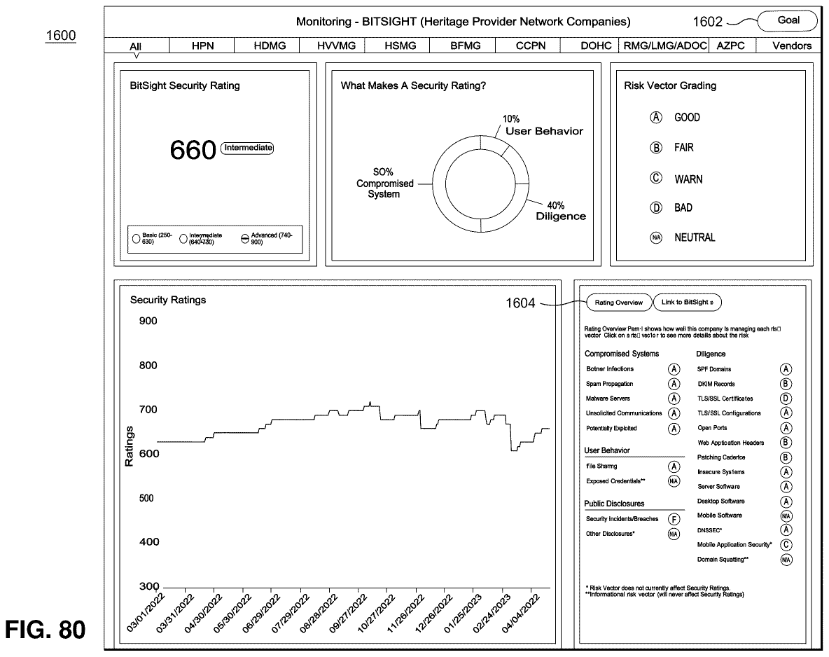

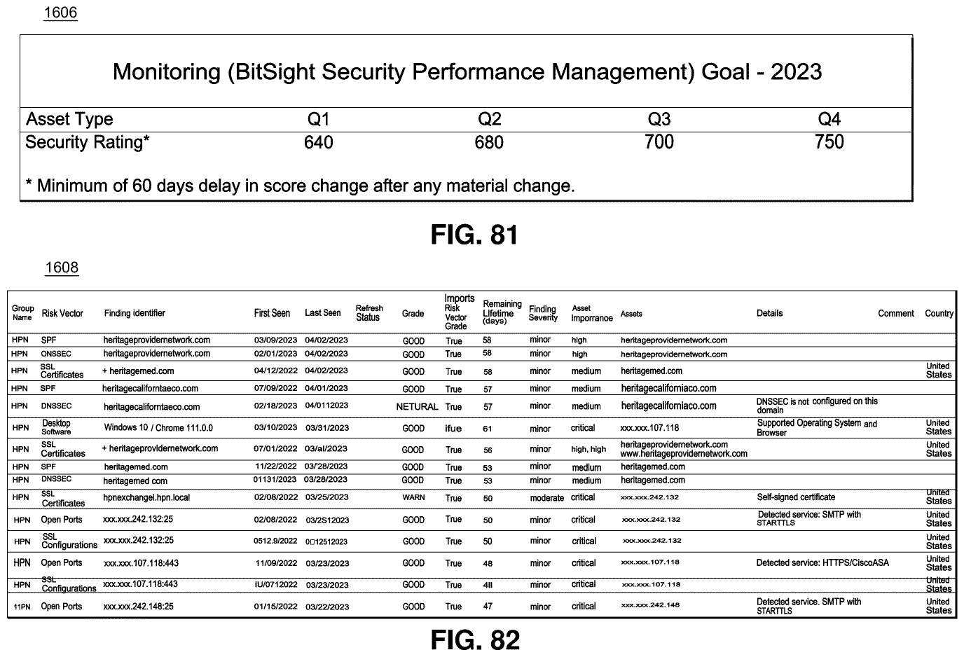

Referring again to the cybersecurity framework page 1000, this time in the state shown in FIG. 79, when a user clicks on the HITRUST controls and monitoring button 1050, a HITRUST popup 1052 may be displayed allowing the user to navigate to the following components: BitSight Security Performance Management, Imperva Web Application Security, SOPHOS MDR, Internal Audit, HITRUST Controls, and HITRUST Maturity Evaluation. FIG. 80 is a screenshot of a security performance management page 1600 of the GUI (which may be accessed using the security performance management link 1053 shown in FIG. 79). The security performance management page 1600 may display a dashboard showing the current security rating (e.g., “660 Intermediate”) according to a cybersecurity ratings company such as BitSight. The dashboard may also show historical security ratings and grades (e.g., A through F) for all risk vectors for each group. By clicking on the goal button 1602 of the security performance management page 1600, the user may see a display 1606 as shown in FIG. 81, showing the objectives for each quarter in the current year. A user may also click on the ratings overview button 1604 to see a list 1608 of findings for each risk vector as shown in FIG. 82.

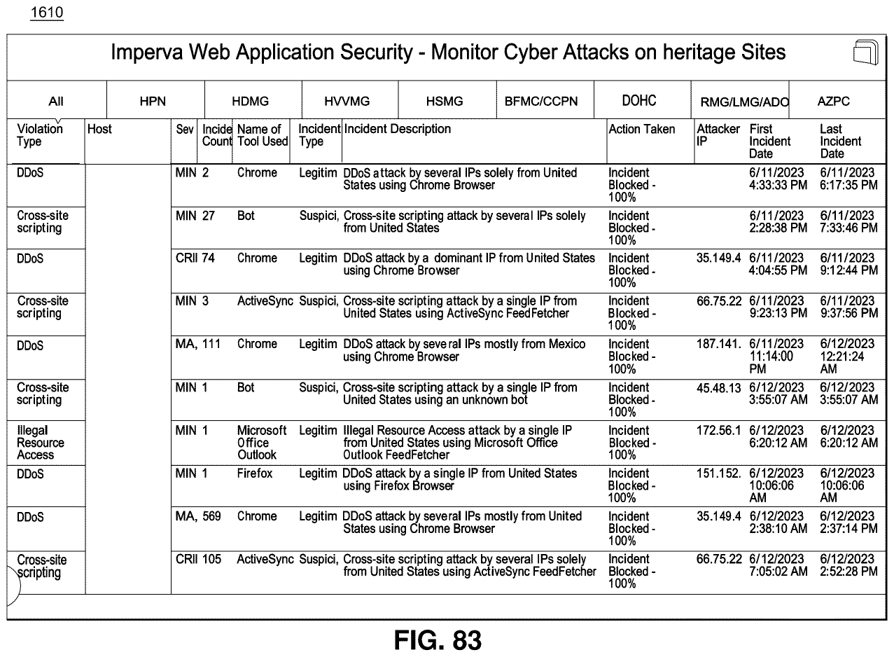

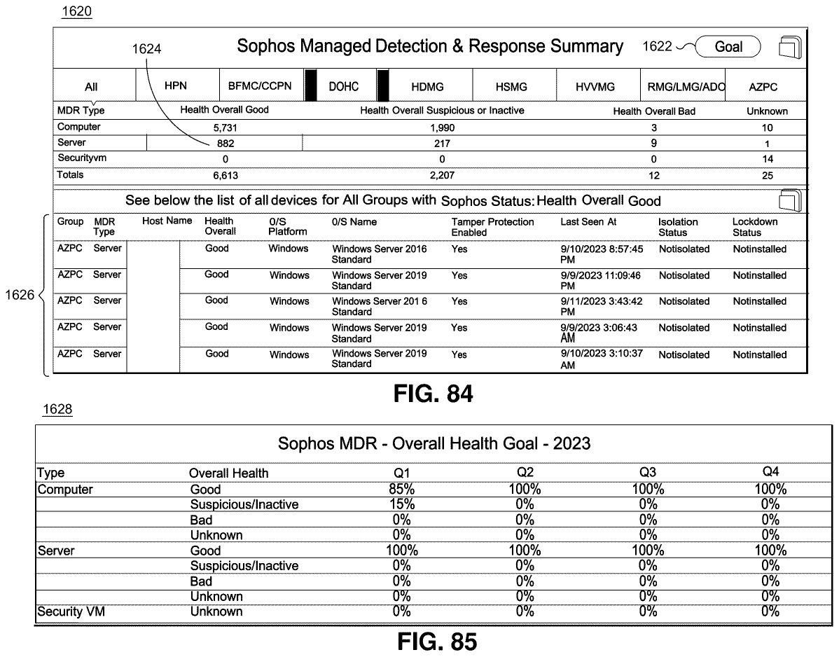

FIG. 83 is a screenshot of a web application security page 1610 of the GUI (which may be accessed using the web application security link 1054 shown in FIG. 79). The web application security page 1610 may display a cybersecurity detection and response summary (e.g., generated using cybersecurity tools developed by Imperva and/or Sophos, for example). FIG. 84 is a screenshot of a managed detection and response summary page 1620 of the GUI (which may be accessed using the Sophos MDR link 1055 shown in FIG. 79). The managed detection and response summary page 1620 may display a SOPHOS managed detection and response (MDR) summary, for example, which may include counts of different systems according to their health (e.g., in a grid, for example). A user may click on a count value 1624 in the grid to see a list 1626 showing the devices having the health associated with the selected count value 1624. By clicking on the goal button 1622 of the managed detection and response summary page 1620, the user may see a display 1628 as shown in FIG. 85, showing the objectives for each quarter in the current year.

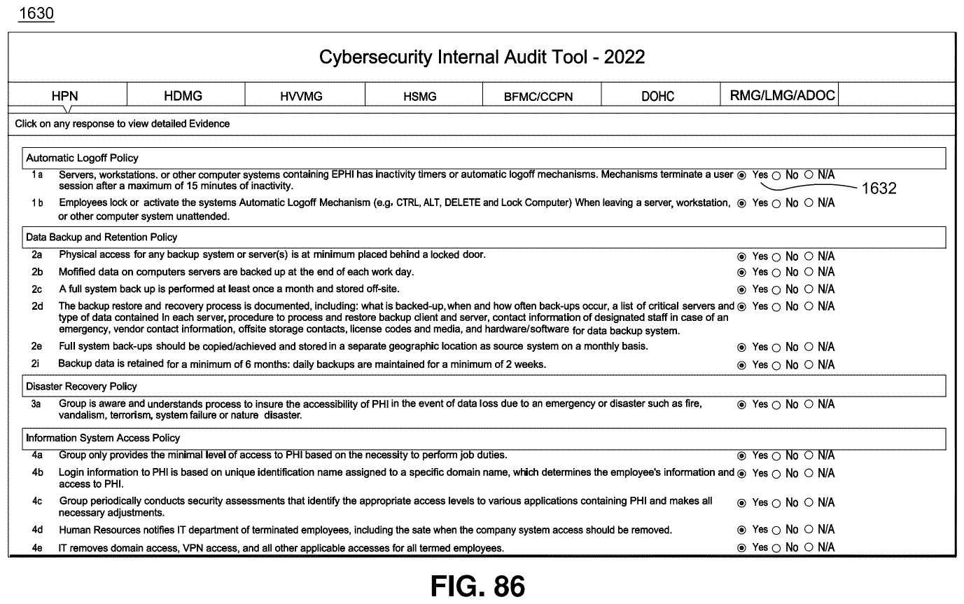

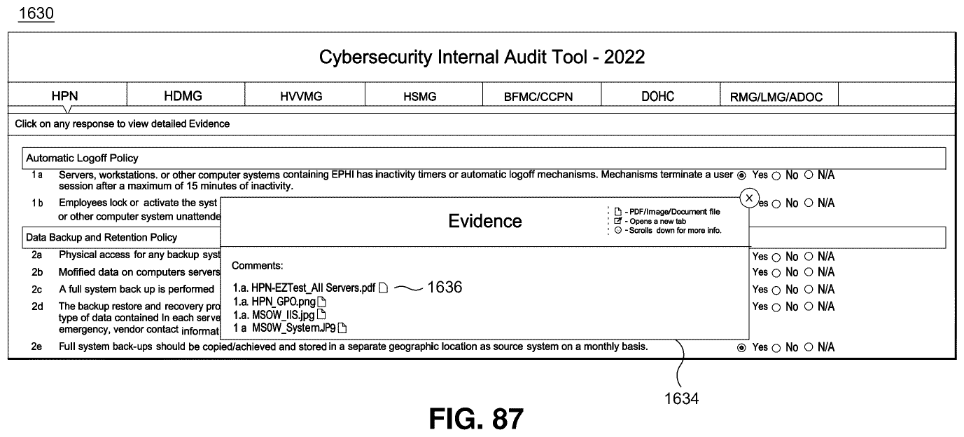

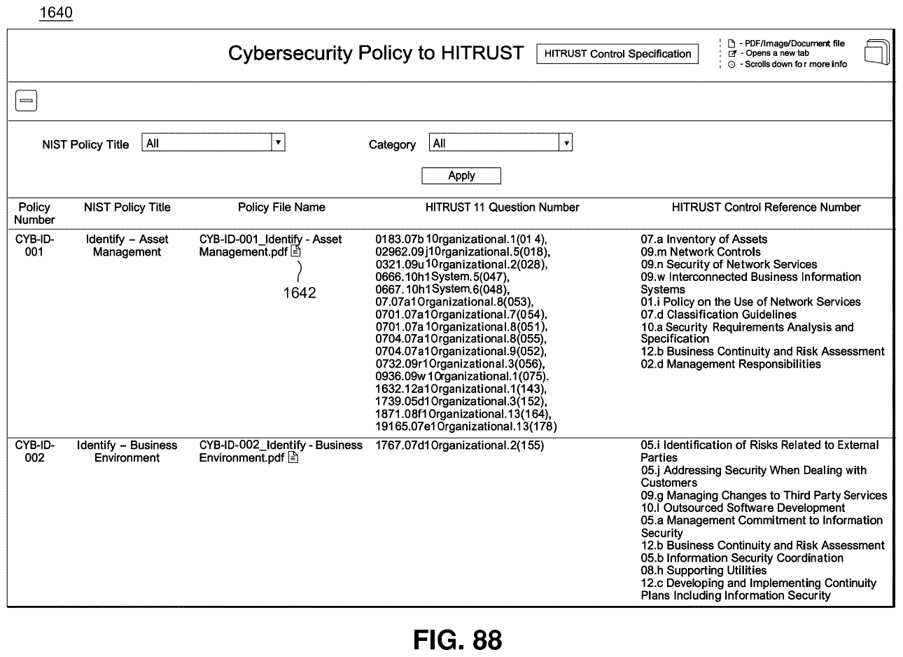

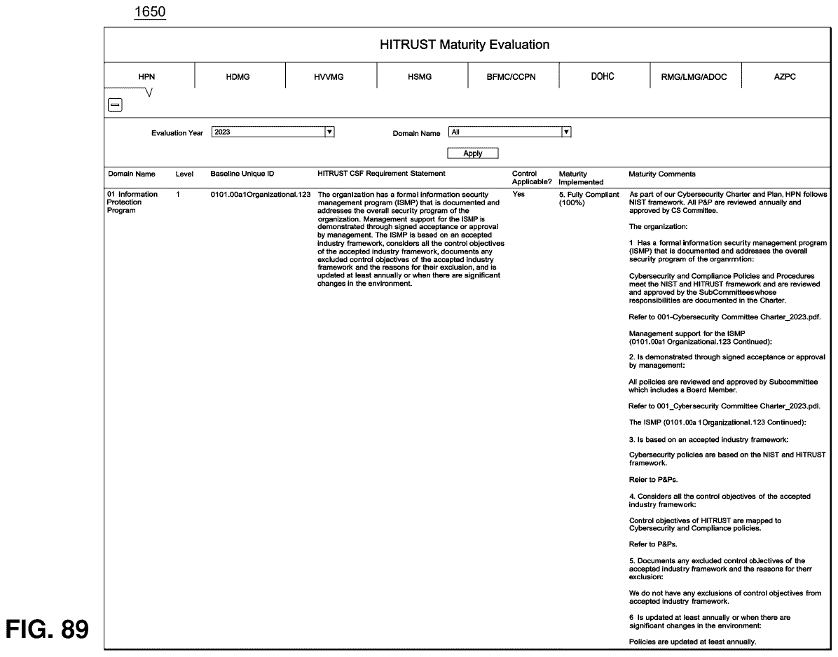

FIG. 86 is a screenshot of a cybersecurity internal audit tool 1630 of the GUI (which may be accessed using the internal audit link 1056 shown in FIG. 79). The cybersecurity internal audit tool 1630 may display questions and answers associated with the audit. A user may click on an answer 1632 (or on the answer section) to open up an evidence popup 1634 as shown in FIG. 87. From here, the user may click on an item of evidence 1636 to open up any related documents. FIG. 88 is a screenshot of a HITRUST controls page 1640 of the GUI (which may be accessed using the HITRUST controls link 1057 shown in FIG. 79). The HITRUST controls page 1640 may display a mapping of the organizations cybersecurity policies to HITRUST controls, along with a filtering tool (e.g., by policy title, category, etc.). FIG. 89 is a screenshot of a HITRUST maturity evaluation page 1650 of the GUI (which may be accessed using the HITRUST controls link 1058 shown in FIG. 79). The HITRUST maturity evaluation page 1650 may display and evaluate how developed the organization is in meeting each HITRUST requirement. A filtering tool may allow a user to filter by evaluation year and domain name, for example.

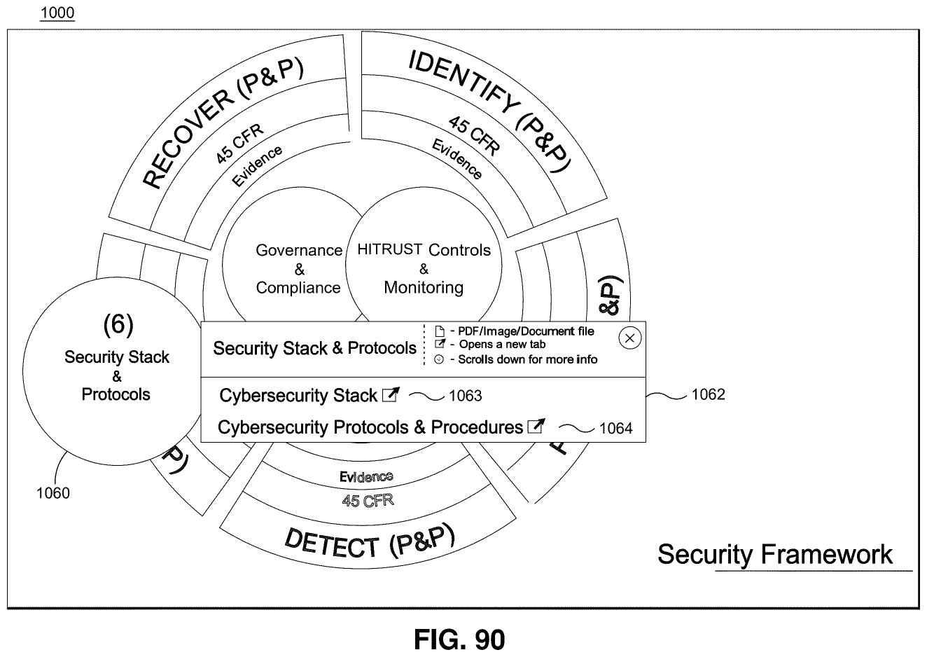

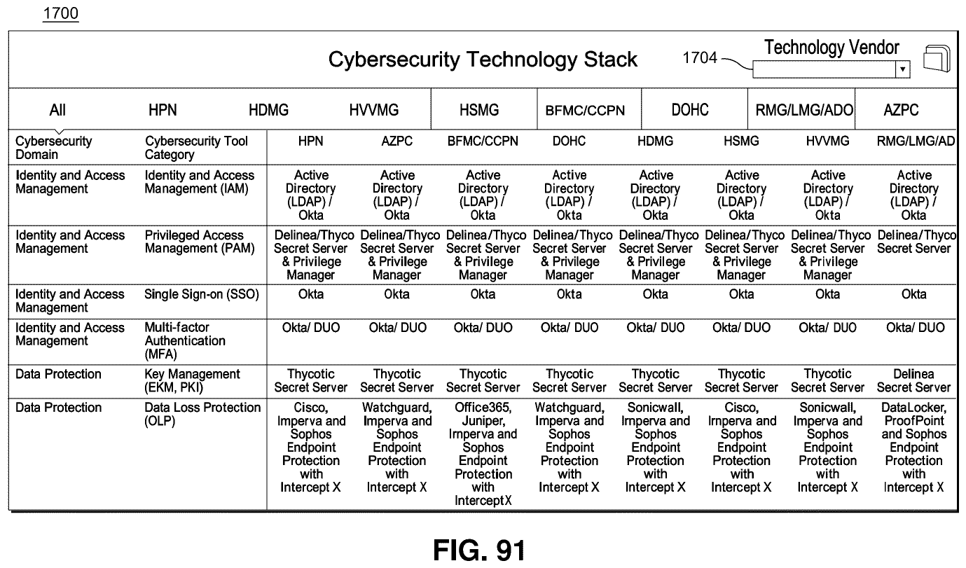

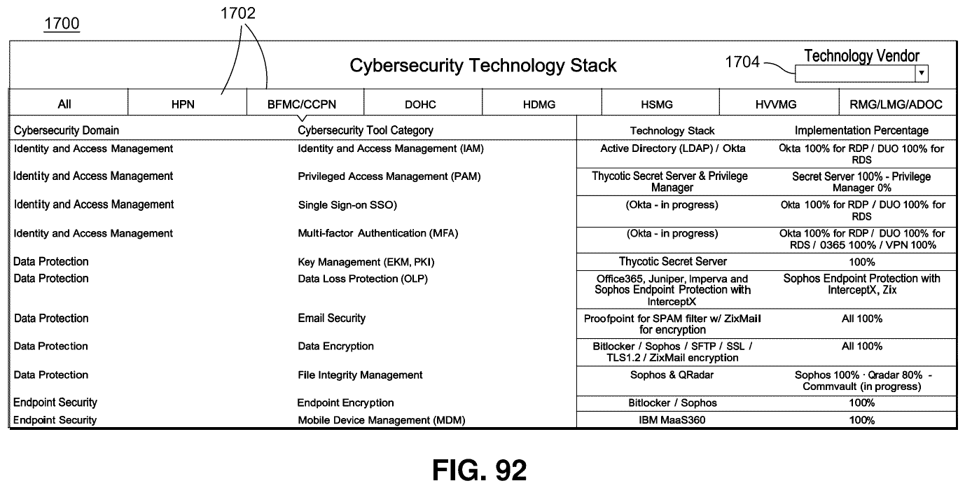

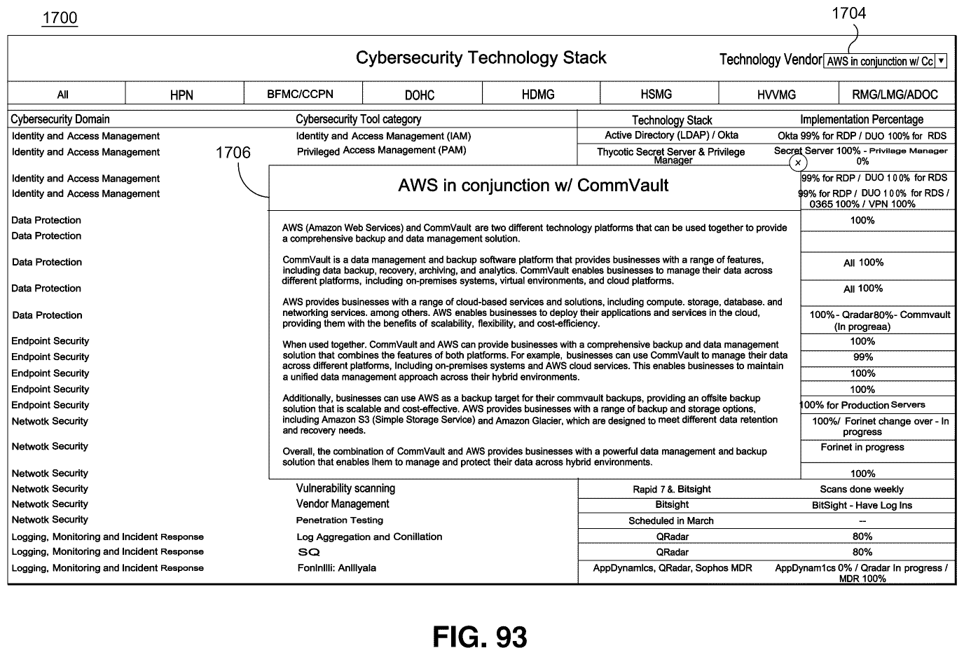

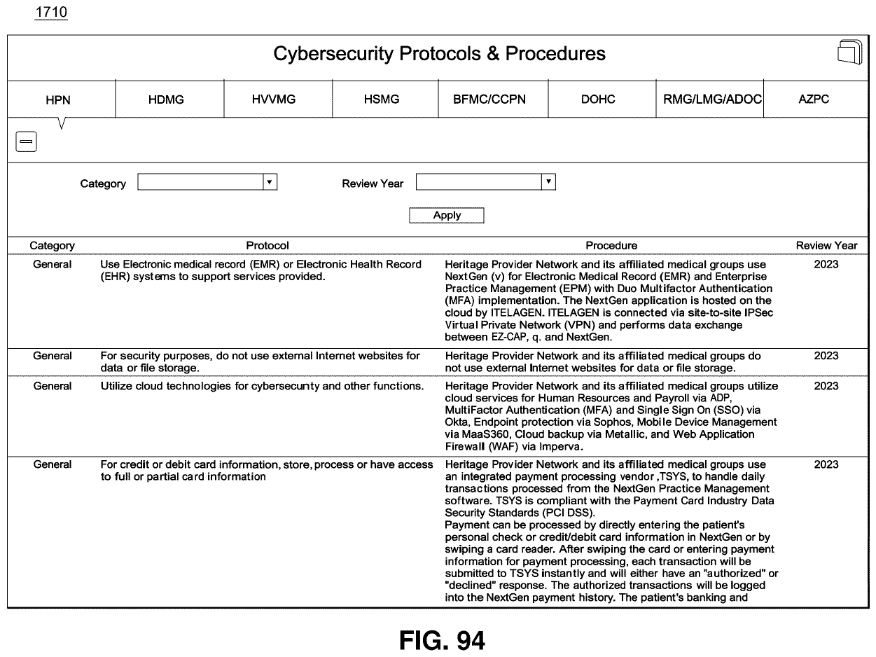

Referring again to the cybersecurity framework page 1000, this time in the state shown in FIG. 90, when a user clicks on security stack and protocols button 1060, a security stack and protocols popup 1062 may be displayed allowing the user to navigate to the following components: Cybersecurity Stack and Cybersecurity Protocols & Procedures. FIG. 91 is a screenshot of a cybersecurity technology stack page 1700 of the GUI (which may be accessed using the cybersecurity stack link 1063 shown in FIG. 90. The cybersecurity technology stack page 1700 may summarize the product/technology used by each group and for each cybersecurity domain and tool category. Clicking on a particular group 1702 as shown in FIG. 92 may display the technology stack and implementation percentage associated with that group. Users can also open a technology vendor dropdown 1704 to select a product or technology and view a popup 1706 providing a detailed writeup of the product/technology utilized by the group as shown in FIG. 93. FIG. 94 is a screenshot of a cybersecurity protocols and procedures page 1710 of the GUI (which may be accessed using the cybersecurity stack link 1064 shown in FIG. 90). The cybersecurity protocols and procedures page 1710 may summarize the protocols used by each group (e.g., selected using the bar at the top) for each cybersecurity domain and tool category. Filters may be provided to refine the search (e.g., by category and review year, for example).

Referring again to the cybersecurity framework page 1000 as shown in FIG. 71, when a user clicks on the governance and compliance button 1040, the governance and compliance popup 1042 may further allow the user to navigate to the following components under the compliance column: organization chart, charter, plan/program, trainings, committee/subcommittee meetings, 45 CFR compliance P&P, newsletter, employee training report, and privacy walk-through attestation. Just as described in relation to the cybersecurity side, clicking on the Organization Chart, Charter, or Plan/Program link under the compliance column will display a downloadable .pdf document of a compliance organization chart (showing current committee members and titles/responsibilities), the current committee charter, or the current compliance plan, respectively. It is noted that the same governance and compliance popup 1042, and/or other compliance-related elements of the cybersecurity framework page 1000 and subpages, may be accessible via the main menu of the Compliance domain.

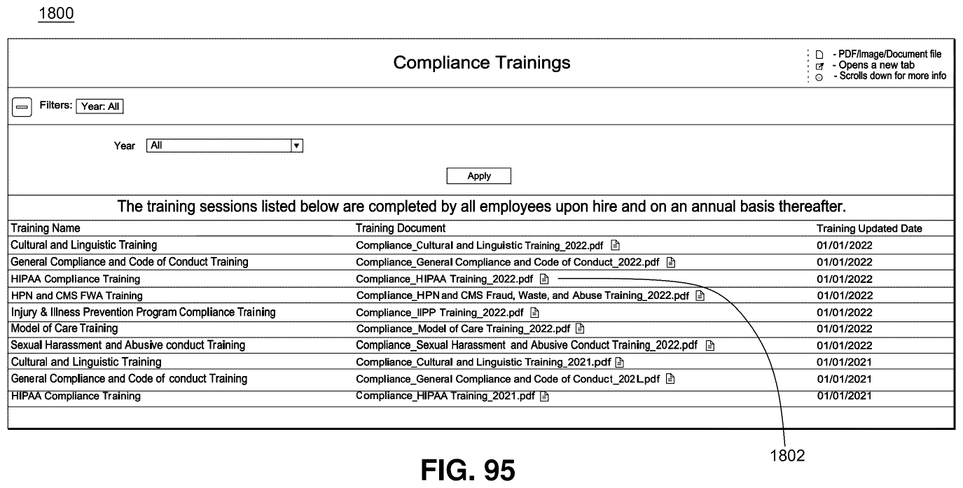

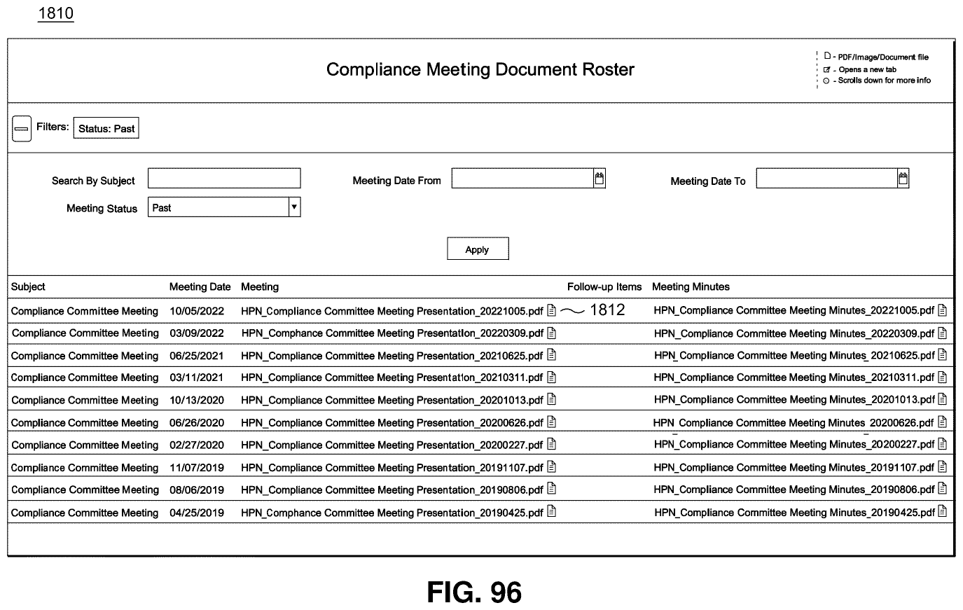

FIG. 95 is a screenshot of a compliance trainings page 1800 of the GUI (which may be accessed using the compliance trainings link 1043b shown in FIG. 71). The compliance trainings page 1800 may display a list of training programs that have been developed for a specific area and may include a filter tool for filtering the list (e.g., by year). Clicking on a link 1802 corresponding to a given training document may display a description of that training program in .pdf format. FIG. 96 is a screenshot of a compliance meeting document roster 1810 of the GUI (which may be accessed using the compliance committee/subcommittee meetings link 1044b shown in FIG. 71). The compliance meeting document roster 1810 may display a list of past meetings with their agendas, meeting minutes, and follow-up items. Clicking on a link 1812 corresponding to a given document may display the document in .pdf format. Advantageously, the compliance trainings page 1800 and compliance meeting document roster 1810 may have substantially the same layout, appearance, and functionality as each other and as other pages of the GUI (such as the cybersecurity trainings page 1500 and cybersecurity meeting document roster 1510 described in relation to FIGS. 72 and 73, above), improving usability thereof.

As described above in relation to FIG. 43, the user may click on the cybersecurity regulations button 45 (i.e., the 45 CFR ring) of a particular cybersecurity function on the cybersecurity framework page 1000 to open a navigation popup 1022 containing the category and number of elements and thereafter navigate to the regulations page 1200 shown in FIGS. 44 and 45. As noted, a regulation 1202 may be clicked to open a pop-up 1210 as shown in FIG. 45, which may contain respective hyperlinks 1212, 1214 to associated Cybersecurity Policy & Procedure documents and Compliance Policy & Procedure documents. The 45 CFR Compliance P&P link 1048 of the cybersecurity framework page 1000 shown in FIG. 71 may similarly navigate the user to the regulations page 1200 shown in FIGS. 44 and 45, and the user may click the hyperlink 1214 to view any relevant compliance Policy & Procedure documents associated with the regulation 1202.

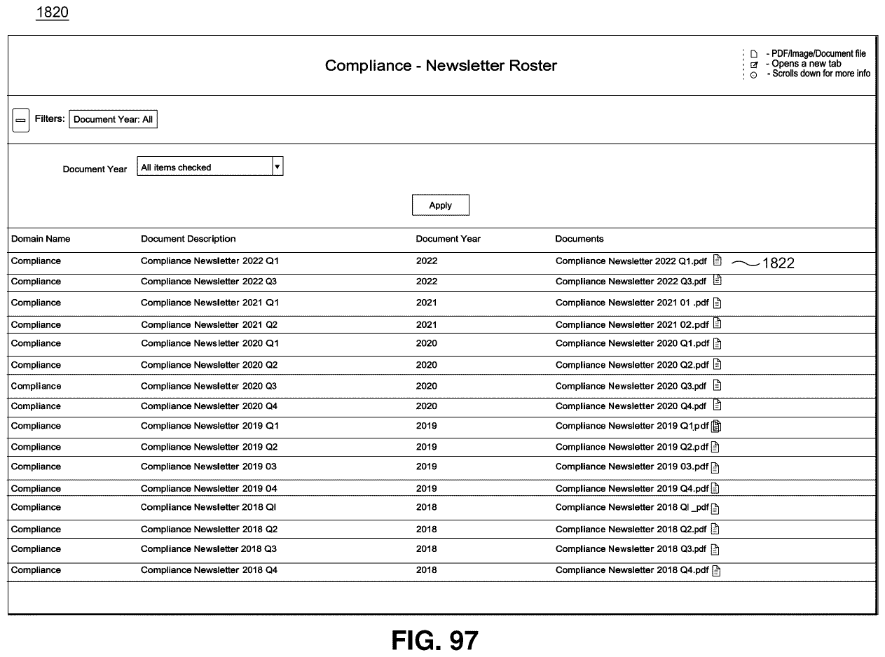

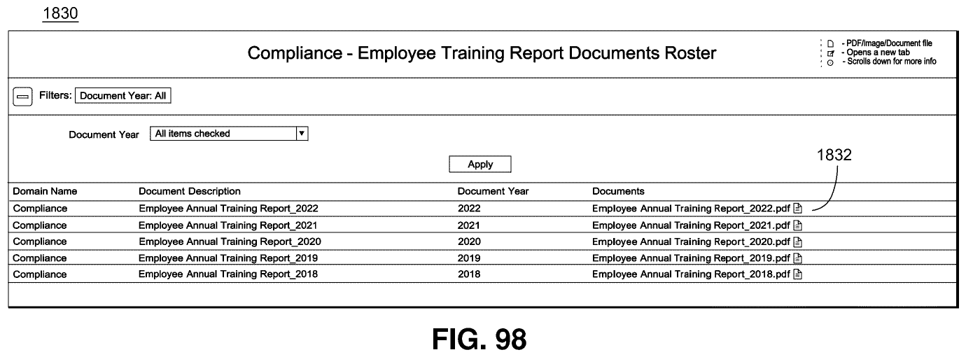

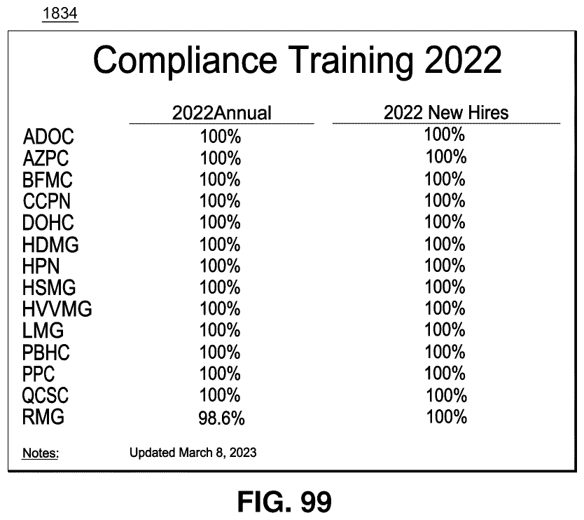

FIG. 97 is a screenshot of a compliance newsletter roster 1820 of the GUI (which may be accessed using the newsletter link 1046b shown in FIG. 71). The compliance newsletter roster 1820 may display a list of past newsletters, which can be filtered by year. By clicking on link 1822, a user may access the associated newsletter in .pdf format. FIG. 98 is a screenshot of a compliance employee training report roster 1830 of the GUI (which may be accessed using the employee training report link 1047b shown in FIG. 71). The compliance employee training report roster 1830 may display a list of past training sessions, which can be filtered by year. By clicking on link 1832, a user may access the associated training document in .pdf format. A report 1834 showing the results of a selected training session may be sorted by group as shown in FIG. 99. Advantageously, the compliance newsletter roster 1820 and compliance employee training report roster 1830 may have substantially the same layout, appearance, and functionality as the cybersecurity newsletter roster 1530 and cybersecurity employee training report roster 1540 described in relation to FIGS. 76-78, above), improving usability thereof.

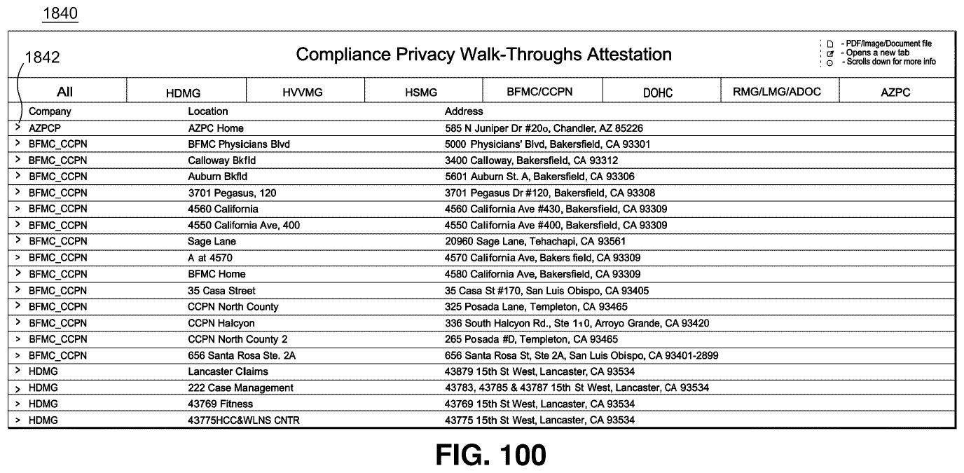

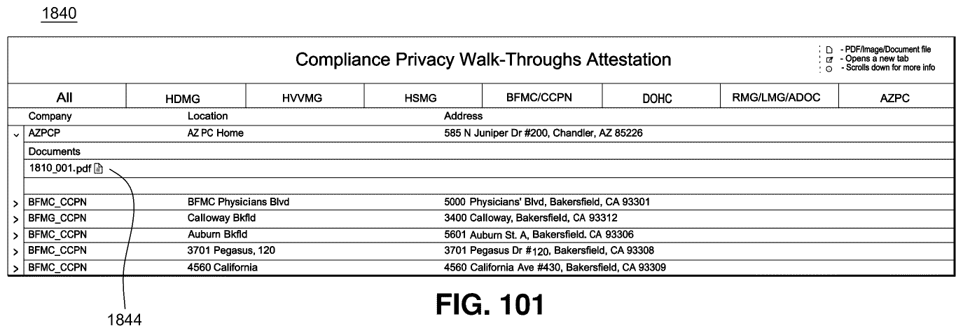

FIG. 100 is a screenshot of a compliance privacy walk-through attestation page 1840 of the GUI (which may be accessed using the privacy walk-through attestation link 1049 shown in FIG. 71). The compliance privacy walk-through attestation page 1840 may display a list of patient privacy assessments in the form of a grid or table. The table may be sorted by group and facility location. By clicking the carrot 1842 (“>”) at the lefthand side of a given entry in the table, the user may expand the entry to display associated documents as shown in FIG. 101. An associated document may show the results of a privacy walk-through for the given day and location. The user may click a link 1844 associated with the document to view and/or download the document in .pdf format.

The functionality described above in relation to the one or more servers that are configured to generate the various pages, tools, and other elements of the graphical user interface (GUI) described herein, as well as the functionality of the computing devices capable of accessing and interacting with the GUI to download/upload documents or read/write stored data, may be wholly or partly embodied in one or more computers including a processor (e.g., a CPU), a system memory (e.g., RAM), and a hard drive or other secondary storage device. The processor may execute one or more computer programs, which may be tangibly embodied along with an operating system in a computer-readable medium, e.g., the secondary storage device. The operating system and computer programs may be loaded from the secondary storage device into the system memory to be executed by the processor. The computer may further include a network interface for network communication between the computer and external devices (e.g., over the Internet), such as between the server(s) configured to generate the GUI and an individual user's computing device. To the extent that any of the described functionality may be performed by a server or computing device, such server or computing device may comprise multiple physical servers and/or other computers that communicate with each other to perform the described functionality.

The above computer programs may comprise program instructions which, when executed by the processor, cause the processor to perform operations in accordance with the various embodiments of the present disclosure. The computer programs may be provided to the secondary storage by or otherwise reside on an external computer-readable medium such as a DVD-ROM, an optical recording medium such as a CD or Blu-ray Disk, a magneto-optic recording medium such as an MO, a semiconductor memory such as an IC card, a tape medium, a mechanically encoded medium such as a punch card, etc. Other examples of computer-readable media that may store programs in relation to the disclosed embodiments include a RAM or hard disk in a server system connected to a communication network such as a dedicated network or the Internet, with the program being provided to the computer via the network. Such program storage media may, in some embodiments, be non-transitory, thus excluding transitory signals per se, such as radio waves or other electromagnetic waves. Examples of program instructions stored on a computer-readable medium may include, in addition to code executable by a processor, state information for execution by programmable circuitry such as a field-programmable gate arrays (FPGA) or programmable logic array (PLA).

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A computer program product comprising one or more non-transitory program storage media on which are stored instructions executable by one or more processors or programmable circuits to perform operations for tracking and maintaining document version history in a multiuser software environment, the operations comprising:
generating a document upload tool to be displayed on a graphical user interface accessible by a plurality of computing devices, the document upload tool including a task selector for selecting among tasks including a first task of uploading a new document and a second task of updating an existing document, the document upload tool further including a version status indicator for indicating, in a case where the second task is selected, whether a file to be uploaded includes redlining relative to a previously uploaded version of the existing document;
receiving a designation of the file to be uploaded; and
preventing the file from being uploaded in a case where the second task is selected, the previously uploaded version of the existing document does not include redlining, and the version status indicator indicates that the file to be uploaded does not include redlining.

2. The computer program product of claim 1, wherein the operations further comprise assigning one or more identifiers to the file to be uploaded.

3. The computer program product of claim 2, wherein the one or more identifiers include a version identifier that is automatically assigned.

4. The computer program product of claim 3, wherein, in a case where the second task is selected, the version identifier is automatically assigned based on a version identifier of the previously uploaded version of the existing document.

5. The computer program product of claim 2, wherein the one or more identifiers include a document type identifier that is selectable from a set of document type identifiers including one or more selected from the group consisting of: Policy & Procedure, Desktop Procedure, Appendix, and Report.

6. The computer program product of claim 2, wherein the document upload tool is accessible from a plurality of domains of the multiuser software environment, each of the plurality of domains being associated with a different department or functional area of a company.

7. The computer program product of claim 6, wherein the one or more identifiers include a document category identifier that is selectable from a predefined set of document categories associated with the particular domain from which the document upload tool is accessed.

8. The computer program product of claim 6, wherein the plurality of domains include two or more domains selected from the group consisting of: compliance, credentialing, cybersecurity, development, California Department of Managed Healthcare (DMHC) filing, eligibility, health plan contract, HR & payroll, quality improvement, revenue, utilization management, and claims.

9. The computer program product of claim 1, wherein the operations further comprise generating a list of documents and corresponding version statuses to be displayed on the graphical user interface, each version status indicating whether the corresponding document includes redlining.

10. The computer program product of claim 9, wherein the operations further comprise generating a document filtering tool to be displayed on the graphical user interface, the document filtering tool including one or more filter selectors for filtering the displayed list of documents.

11. The computer program product of claim 10, wherein the one or more filter selectors include a version status filter selector for selecting whether documents that include redlining appear in the list of documents.

12. The computer program product of claim 9, wherein the operations further comprise providing respective links for opening each document in the list.

13. The computer program product of claim 1, wherein the operations further comprise:
generating a group email management tool to be displayed on the graphical user interface, the group email management tool including one or more selectors for selecting user email addresses to receive automatic email notifications of new documents and updates to existing documents; and,
in response to the file being uploaded, sending an email notification to the selected user email addresses.

14. The computer program product of claim 13, wherein the document upload tool and the group email management tool are accessible from a plurality of domains of the multiuser software environment, each of the plurality of domains being associated with a different department or functional area of a company.

15. The computer program product of claim 14, wherein the email notification is sent to the selected user email addresses in response to the file being uploaded from the same particular domain in which the user email addresses were selected.

16. A method of tracking and maintaining document version history in a multiuser software environment, the method comprising:
generating a document upload tool to be displayed on a graphical user interface accessible by a plurality of computing devices, the document upload tool including a task selector for selecting among tasks including a first task of uploading a new document and a second task of updating an existing document, the document upload tool further including a version status indicator for indicating, in a case where the second task is selected, whether a file to be uploaded includes redlining relative to a previously uploaded version of the existing document;
receiving a designation of the file to be uploaded; and
preventing the file from being uploaded in a case where the second task is selected, the previously uploaded version of the existing document does not include redlining, and the version status indicator indicates that the file to be uploaded does not include redlining.

17. A system for tracking and maintaining document version history in a multiuser software environment, the system comprising:
one or more servers configured to generate a document upload tool to be displayed on a graphical user interface accessible by a plurality of computing devices, the document upload tool including a task selector for selecting among tasks including a first task of uploading a new document and a second task of updating an existing document, the document upload tool further including a version status indicator for indicating, in a case where the second task is selected, whether a file to be uploaded includes redlining relative to a previously uploaded version of the existing document; and
a first computing device configured to access the graphical user interface and designate the file to be uploaded;
wherein the one or more servers prevents the file from being uploaded in a case where the second task is selected, the previously uploaded version of the existing document does not include redlining, and the version status indicator indicates that the file to be uploaded does not include redlining.

18. The system of claim 17, further comprising a second computing device configured to access the graphical user interface, wherein the one or more servers is further configured to generate a list of documents and corresponding version statuses to be displayed on the graphical user interface, each version status indicating to a user of the second computing device whether the corresponding document includes redlining.

19. The system of claim 18, wherein the one or more servers is further configured to generate a document filtering tool to be displayed on the graphical user interface, the document filtering tool including one or more filter selectors by which the user of the second computing device may filter the displayed list of documents.

20. The system of claim 19, wherein the one or more filter selectors include a version status filter selector by which the user of the second computing device may select whether documents that include redlining appear in the list of documents.
